(19) United States
(12) Patent Application Publication
(10) Pub. No.: US 2018/0238775 A1
(43) Pub. Date: Aug. 23, 2018

(54) SAMPLE COLLECTION SYSTEM

(71) Applicant: FRONTIER BIO SYSTEMS, INC., Hachioji-shi (JP)

(72) Inventors: Hideki KAMBARA, Tokyo (JP); Masahito HOSOKAWA, Tokyo (JP); Haruko TAKEYAMA, Tokyo (JP); Takuya YODA, Tokyo (JP)

(73) Assignee: FRONTIER BIO SYSTEMS, INC., Hachioji-shi (JP)

(21) Appl. No.: 15/942,249

(22) Filed: Mar. 30, 2018

Related U.S. Application Data
(63) Continuation-in-part of application No. PCT/JP2016/079326, filed on Oct. 3, 2016.

(30) Foreign Application Priority Data
Oct. 7, 2015 (JP) 2015-199551

(51) Int. Cl. G01N 1/08; G01N 1/14; G01N 1/28; B01L 3/00

(52) U.S. Cl. CPC G01N 1/08; B01L 3/502715; G01N 1/28; G01N 1/14

(57) ABSTRACT

The purpose of the present invention is to provide a sample collection system capable of repeatedly collecting a sample. The present invention discloses a system including: at least one or multiple hollow collection needle(s) each having a knife edge for collecting the sample from a biological specimen; and a syringe, a solenoid and a reservoir that serve as a liquid-inflow mechanism allowing a solution to flow into the collection needle, wherein the sample is ejected from the collection needle together with the solution so as to recover the sample.

### CROSS-REFERENCE TO RELATED APPLICATIONS

The present application is a continuation application of International Application No. PCT/JP2016/079326, filed Oct. 3, 2016, which claims priority to Japanese Patent Application No. 2015-199551, filed Oct. 7, 2015. The contents of these applications are incorporated herein by reference in their entirety.

### BACKGROUND OF THE INVENTION

### Field of the Invention

The invention is related to a sample collection system for mass and rapid collection of single cells as well as micro tissue dissections from biological specimens of animals and plants for use in various biological analyses.

### Background Art

By the completion of the Human Genome Project, the movements to understand and utilize life based on genes or expression of genes have become increasingly active. Under these circumstances, there has been a growing recognition that biological pathological tissues including cancer, etc. are aggregates of various cell groups, and hence the detailed examination of gene (genome), gene expression (transcriptome analysis), metabolite (metabolome), or protein (proteome), etc., for each cell or cell aggregate (tissue section) constituting the tissues is necessary in order to understand diseases and respond thereto properly. Against this background, the movement for comprehensive and detailed analysis of genome, mRNA (transcriptome), metabolite (metabolome), protein, etc. in one cell has become active.

On the other hand, the single cell measurement technologies are useful for analyzing floating cells such as immune cells. However, cells in a tissue can not be analyzed as they are. They have to be isolated from each other before analysis, and then an analysis such as gene expression is conducted on the ones thus isolated. Such isolation process, however, often impair actual cellular states. Therefore, the analyses of cells or cell aggregates that are as natural as possible have been desired. As a solution to meet such need, one approach has been proposed and rated as promising, which is to use microdissections rather than a large tissue fragment. For that purpose, there has heretofore been employed Laser-capture micro dissection (LCM) system as a sectioning and collecting method using a laser (e.g., commercially available products from company A as stated later). This LCM system, however, is expensive and constrained by specimens capable of being subjected to dissecting process, and hence, a more simple system has been required.

More recently, there has been developed a system picking up cells with a glass capillary. As glass is fragile, this system is not suitable for use with a biological specimen such as a plant specimen having hard cell walls. On the other hand, the present inventors ever realized a microdissection system using a hollow needle that has a sharpened tip and is in the form of a stainless pipe having a four-pointed tip (WO 2013/125141). However, such hollow needle having the sharpened tip is easily damaged at its tip, and thus there has been a need to keep a target biological specimen in place on a gel plate. Further, there has been a drawback that the biological specimen moves or deforms at the time of collection thereof, which has inhibited the accurate site specific collection of microdissections.

Further, according to the collection systems using such hollow needle or capillary, there has been a need to replace the capillary with a new one or to clean up the tip of the hollow needle by dipping the same in a cleaning solution, every time a new sample is picked up, leading to difficulties in speedily repeating collections, requiring long hours for collection of samples from hundreds of sites. Taking long hours to collect samples may make it difficult to retain the shape of a target biological specimen when the specimen is a frozen tissue slice or the like, and hence, decomposition of biological molecules such as RNA is unavoidable. Therefore the sample collections by the conventional systems have been limited to the cases for collecting small numbers of samples, and it has been impossible for the conventional systems to perform sampling from various positions in one specimen. For the moment, the publicly known sample collecting systems are the ones allowing a collecting needle to move along X, Y, and Z axes for collecting and recovering samples or those manually collecting and recovering samples. In both cases, the processes of collecting and recovering samples take much time, which has been a drawback of the known systems. That is partly due to the fact that for collecting samples, a stepping motor having a small step size is suitable because collection is carried out while performing the precise position control along a plane on which a biological sample is placed; for recovering samples, a stepping motor having a large step size is suitable because a long travel distance is necessary for carrying the collection needle to a macro device such as a titer plate, which requires numerous steps if performed using a small-step stepping motor with an enhanced precision, thus prosing a problem that traveling hours become long.

On the other hand, in order to let collected samples undergo DNA, proteome, protein, and gene expression analyses, sections of the collected samples have to be transferred to small reaction chambers. Therefore, it has been desired to develop such a system that enables all of them to be performed smoothly. Further, in the case of single cell analysis, target cells are cultured in a recovery plate (micro-chamber plate) having a number of micro chambers, followed by detecting the target cells by fluorescence labels through antigen-antibody reaction, and then the target cells on the micro-chamber plate are transferred to a titer plate for the sample preparation reactions, which are time consuming and labor intensive. Although dedicated automated systems for such transfer have been developed, they have had a drawback that it takes several tens of seconds to several minutes to transfer one cell.

### SUMMARY OF THE INVENTION

The purpose of this invention is to overcome these drawbacks to provide a sample collection system which can easily and repeatedly collect sample microdissections from biological specimens of animals as well as those of plants. This invention can be also used for transferring cells on a micro-chamber plate to a titer plate. Further, this invention realizes such a system enabling not only collection of single cells and micro tissue dissections but also sample preparation that can appropriately respond to subsequent, various subjects of analysis.

The sample collection system of this invention includes: one or multiple hollow collection needles for collecting samples from a biological specimen; and

a liquid-inflow mechanism to flow liquid through the inner region of each hollow collection needle,
wherein the samples are recovered by ejecting the samples from the collection needles together with the liquid.

The sample collection system of this invention may further include:

a specimen placement container to place the biological specimen therein;
a specimen holder to hold the specimen placement container; and
a storage portion to store the samples thus collected.

The sample collection system of this invention may further include: a collection needle actuation mechanism to move the collection needle; and a specimen holder actuation mechanism to move the specimen holder.

The sample collection system of this invention may further include: a holding body to hold the biological specimen in a manner capable of being cut and penetrated by the collection needle;

a specimen holder to hold the holding body holding the biological specimen;
a mounting board to mount the specimen holder thereon;
a collection needle actuation mechanism to move the collection needle along one axis when collecting the samples; and
a specimen holder actuation mechanism to move the specimen holder on a plane orthogonal to the one axis.
wherein the biological specimen is cut by the collection needle to collect the samples.

The sample collection system of this invention may further include:

a storage portion to store the samples; and
a storage portion actuation mechanism to move the storage portion along at least one axial direction orthogonal to the one axis,
wherein the storage portion includes multiple reaction chambers to store the samples.

The sample collection system of this invention may further include one or multiple fluidic channels along which the samples flow together with liquid, wherein the samples are allowed to flow by the flow of the liquid in the fluidic channels.

The sample collection system of this invention may be the one in which the collection needle partly constitutes the fluidic channels.

The sample collection system of this invention may be the one in which the fluidic channels are provided below the holding body, and the tip end portion of the collection needle is arranged above the fluidic channel in the transverse direction thereof.

The sample collection system of this invention may be the one in which the specimen holder is provided to mount the holding body thereon, and the fluidic channel is provided on the specimen holder or the mounting board, and wherein the system further comprises one or multiple sample collection gates that are communicated with the fluidic channel and are arranged below the holding body.

The sample collection system of this invention may be the one in which the tip end portion of the collection needle is insertable into the fluidic channel or the sample collection gates communicated with the fluidic channel.

The sample collection system of this invention may be the one in which the fluidic channel is provided above the mounting board.

The sample collection system of this invention may further include a sample preparation system for analyzing or examining the samples, wherein the fluidic channel or the collection needle is communicated with the sample preparation system.

The sample collection system of this invention may be the one in which the samples are discharged from the tip end portion of the collection needle together with liquid.

The sample collection system of this invention may be the one in which the samples are discharged from a portion of the collection needle other than the tip end portion thereof together with liquid.

The sample collection system of this invention may further include an observation device to determine at which site in a biological specimen the sample is to be collected according to image information on the specimen obtained by the observation device.

The sample collection system of this invention may further include a vibration mechanism for vibrating the collection needle or a rotation mechanism for rotating the collection needle, wherein the collection needle is provided in a vibratable or rotatable manner.

The sample collection system of this invention may be the one in which the storage portion moves independently from the specimen holder, and is capable of moving faster than the specimen holder.

The sample collection system of this invention may be the one in which reference point(s) or reference line(s) are provided on the holding body in order to determine a position on the two-dimensional coordinates, and collection sites can thus be determined based on the reference point(s) or reference line(s).

The sample collection system of this invention may be the one in which the two-dimensional coordinates of the holding body can be transformed into the two-dimensional coordinates of the specimen holder or the two-dimensional coordinates of the specimen holder actuation mechanism.

The sample collection system of this invention may be the one in which the collection needle is movable on a plane orthogonal to the one axis.

The sample collection system of this invention may be the one in which the collection needle is capable of rotating around an axis parallel to the one axis thereof.

The sample collection system of this invention may be the one in which the biological specimens include tissue materials; cells; a group of cells; cells that are dispersed and retained on a sheet; a cell group that is dispersed and retained on a sheet; or a cell group captured by a micro chamber array etc.

The sample collection system of this invention may be the one in which the biological specimen is selected from tissue slices or cells.

The sample collection system of this invention may be the one in which the tip end portion of the collection needle is formed into a cylindrical shape.

The sample collection system of this invention may be the one in which the collection needle is made of metal, glass, polymer coated glass, or polymers.

According to the present invention, there can be provided a sample collection system which can easily and repeatedly collect microdissections, as samples for various analyses, from biological specimens of animals as well as those of plants in a short time.

### BRIEF DESCRIPTION OF THE DRAWINGS

FIG. 1 is a schematic view of a sample collection system, as viewed from front, according to example 1 of the present invention.

FIG. 2 is a longitudinal sectional view of a collection needle used in the sample collection system thereof.

FIG. 3 is a schematic view of the collection needle in a fixed condition, as viewed from front.

FIG. 4 is a block diagram showing an electrical structure thereof.

FIG. 5 is a plane view of a specimen holder with a sheet holding the specimen.

FIG. 6 is a schematic view of the sample collection system, as viewed from front, according to example 2 of the present invention.

FIG. 7 is a schematic view of the sample collection system, as viewed from front, according to example 3 of the present invention.

FIG. 8 is a schematic plane view of a main section of the sample collection system according to example 4 of the present invention.

FIG. 9 is a schematic view of the sample collection system according to example 5 of the present invention, in which FIG. 9A is a schematic view thereof, as viewed from front, and FIG. 9B is a schematic longitudinal section thereof.

FIG. 10 is a schematic view of the sample collection system, as viewed from front, according to example 6 of the present invention.

FIG. 11 is a schematic view of the sample collection system, as viewed from front, according to example 6 of the present invention, with a fourth capillary tube being attached.

FIG. 12 is a schematic view of the sample collection system, as viewed from front, according to example 7 of the present invention.

FIG. 13 is a schematic view of the sample collection system, as viewed from front, according to example 8 of the present invention.

FIG. 14 is a schematic view of the sample collection system, as viewed from front, according to example 9 of the present invention.

### DETAILED DESCRIPTION OF THE INVENTION

In this specification, a “biological specimen” refers to that obtained from biological bodies such as animals, humans, plants or microbes for the purpose of carrying out, for example, observation, analysis, diagnosis of disorders, prediction of risks of possible future disorders, or experiments on a part or whole part of an individual of any of these biological bodies or on a group of multiple biological bodies. Specifically, the biological specimen refers to, for example, an animal, human or plant-derived tissue material; a slice section thereof; cells of an animal, plant or microorganism; a cell group thereof; these cells that are dispersed and retained on a sheet; a cell group that is dispersed and retained on a sheet; or a cell group captured by a micro chamber array or the like. The biological specimen also includes materials for biopsy that are taken from patients with disorders.

Here, a “sample” refers to that collected for the purpose of carrying out, for example, observation, analysis, diagnosis of disorders, prediction of risks of possible future disorders, or experiments on a part or whole part of the abovementioned “biological specimen.”

“Titer plate” refers to a plate having a plural of reaction chambers, chambers or wells for storing samples taken from a biological specimen. For example, there may be used a commercially available microplate having 6, 8, 12, 24, 48, 96, 384, or 1536 wells or chambers. Further, multiple microplates of such type may be joined to one another at the time of use.

In this specification, “observation device” refers to a device to obtain image information of a biological specimen, the examples of such device including an optical microscope, a fluorescent microscope, a Raman microscope and a video camera. By using such observation device to observe a biological specimen, it is possible to determine the collection site of a sample.

In the system of the present invention, a collection needle is moved along at least one axis direction for collection. In this specification, this direction is described as a Z axis, and a plane orthogonal to the Z axis is called an X-Y plane. Through a holding body, a biological specimen is mounted on and held by a specimen holder capable of moving along a direction other than the Z axis direction e.g. the direction of the X-Y plane. The collection site of the biological specimen is moved to and positioned at a collection location on the Z axis as a moving axis of the collection needle, followed by moving the collection needle in the Z axis direction so as to cut and collect the collection site of the biological specimen, thus collecting the sample. However, there are cases where the Z axis represents a vertical direction, and the X-Y plane is a plane in the horizontal direction. Further, when storing the collected sample in a storage portion, the collection needle may move along another one or two axis directions that are orthogonal to the Z axis.

More specifically, the collection needle used in the present invention is a pipe-shaped collection needle that is smoothly thinned into the shape of a knife toward the tip end portion thereof, and has a tip curvature radius of 10 μm or smaller. Using such collection needle, even the holding body holding a biological specimen such as tissues and cells can be cut and collected all together. In this case, it is useful to avoid the collecting failure of the sample if suction is performed by reducing the pressure of a solution reservoir connected to the collection needle at the time of collection. In addition, by applying a micro vibration and/or a rotation to the collection needle if necessary at the time of collecting a sample, a sample may be able to be cut and collected with a small force. The collection needle is capable of being repeatedly used, and has a function such that since the collection needle is formed into the shape of a pipe, a solution can flow into the collection needle before collecting, and that at the time of ejection, the collection needle is vibrated if necessary to eject the collected sample and the solution to a given recovery site while washing the inner side of the hollow collection needle with the solution. Since the solution goes through the inside of the hollow collection needle even when the collection needle is not vibrated, there can be achieved a sufficient washing effect. When collecting, the collection needle merely moves along one axis (Z axis), whereas the specimen holder finely moves a part of a biological specimen to be collected to a collection position along the X-Y plane. Meanwhile, a sample collected can be recovered in a reaction chamber of a titer plate which can move a long distance, or recovered in a reaction chamber using a microfluidic channel provided on, inside or under the specimen holder. Moreover, with the collection position for capturing the sample with the collection needle being the point of origin, the collection needle can be largely moved in the X, Y directions toward the titer plate so as to recover the sample collected. Further, the collection needle may be moved in the X axis direction orthogonal to the Z axis direction, and the titer plate may be moved in the Y axis direction. If using the microfluidic channel, the sample may be ejected into the microfluidic channel, and then flow along the microfluidic channel to be successively recovered by reaction chambers of a titer plate equipped with multiple reaction chambers. In such case, since the collection and recovery of a sample are carried out in a substantially successive manner, a collection time is substantially determined by a moving time of the specimen holder, which makes it possible to realize sample collection at a high speed. The titer plate equipped with the reaction chamber(s) can move to the next reaction chamber recovery position while the specimen holder is moving.

In this way, by independently controlling the precise movements of the specimen holder, moving the collection needle in the vertical and horizontal directions, and moving the recovery plate, rapid and accurate sample collection can be carried out automatically. By ejecting the sample collected into the microfluidic channel, a sample preparation reaction(s) thereafter can be performed using a microfluidic device. Thus, a process from sample collection to sample preparation can be conducted rapidly in a fully automated manner. Moreover, with regard to the ejection of a sample or wash solution, the collection needle is vibrated also to allow washing to take place in a short period of time, thereby allowing the collection needle to be used repeatedly, thus enabling a rapid repetitive collection.

Further, with regard to a system having no microfluidic channel, for example, there may be employed a system equipping two actuators with different strokes in one step. For moving a collection site to the collection position, it requires a precise control of position; and for the recovery of a collected sample, it requires only a rough position control, but a long-distance movement.

In addition, although the system of the present invention performs collection by moving the collection needle along the Z axis down to the collection position being the point of origin on the X-Y plane, the collection needle may be able to move along an axis other than the Z axis as well. In such case, an observation device is to be arranged on an upper portion of the specimen holder, followed by observing a specimen while the collection needle is not at the point of origin (on the Z axis) so as to move the collection site of the specimen to a collection position, and then allow the collection needle to return to the point of origin to conduct the action of collection. Further, collection may also be performed in a way such that the observation of the specimen may be conducted in the vicinity of a virtual point of origin which is deviated from the point of origin of the X and Y axes, without moving the collection needle in the directions of the X and Y axes, and that after moving the collection site of a biological specimen to the virtual point of origin, such virtual point of origin is moved to the point of origin (moved along one axis over a given distance), and the collection needle is actuated along the Z axis to carry out collection. Since this type of system can eliminate visual field disturbance caused by the collection needle, it has an advantage of being able to utilize a microscope system that is commonly utilized.

Further, by using multiple collection needles, multiple samples may be simultaneously collected and then independently recovered. There may be used one or more collection needles, 1 to 10, 1 to 30, 1 to 50, or 1 to 100 collection needles, specifically, 1, 2 or more, 10 or more, 30 or more, 50 or more, or 100 or more collection needles. Moreover, corresponding to the number of chambers on a commercially available microplate, the number of the collection needles may also be 6, 8, 12, 24, 48, 96, 384 or 1536. Likewise, there may be provided multiple sample collection gates serving as receiving gates of a sample, and multiple fluidic channels. Also, the collection needle(s) may be configured as a honeycomb structure so that multiple fragment samples can be simultaneously collected.

When picking up cells, and taking out cells stored in micro reaction chambers of a microplate, suction with a pipet or the like has been performed. However, most cells are adhesive, which often makes suction difficult. Even for such a kind of biological specimen, the present invention functions effectively because of cutting and collecting a sample together with a sheet member to which cells are adhered.

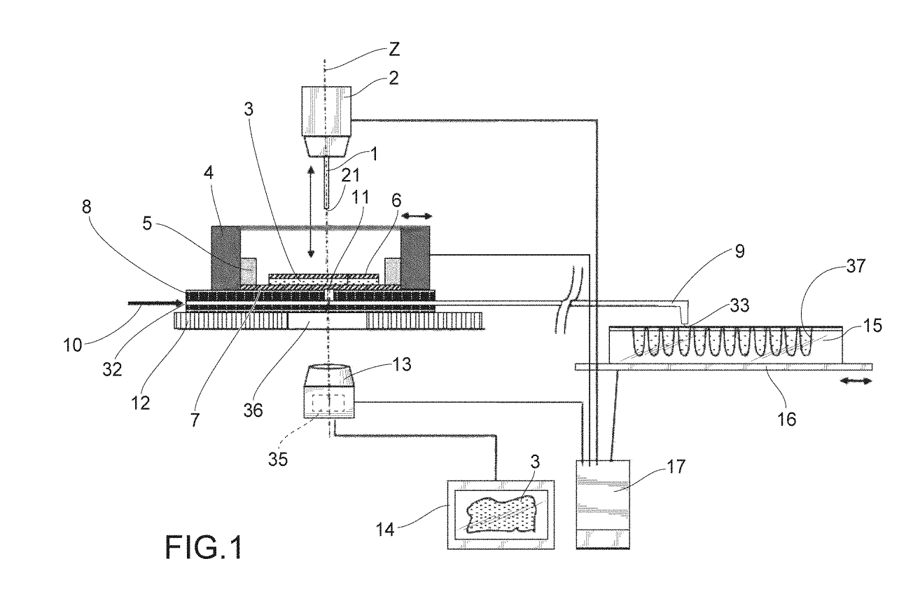

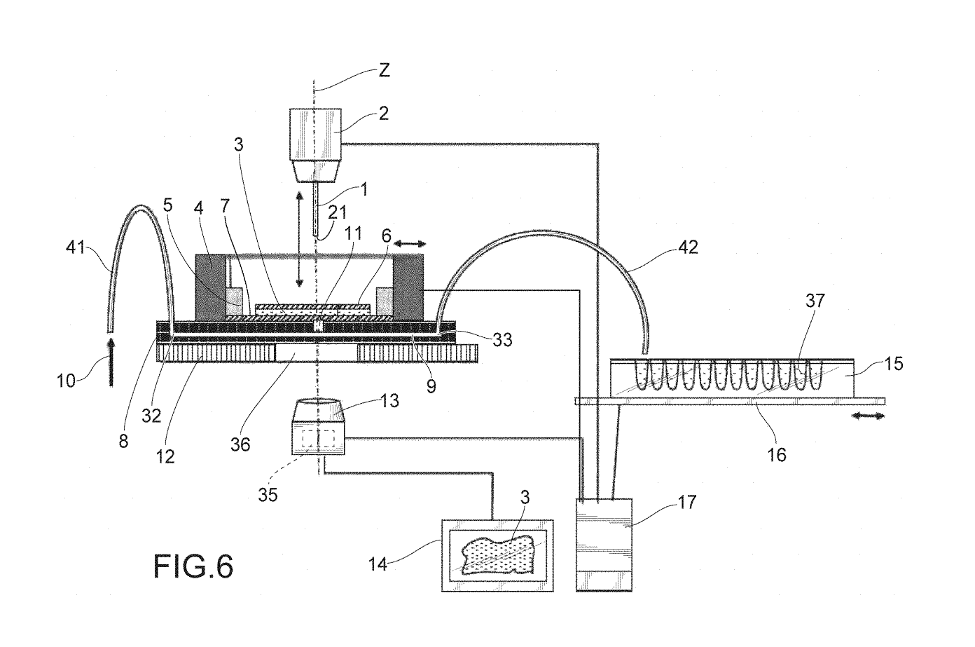

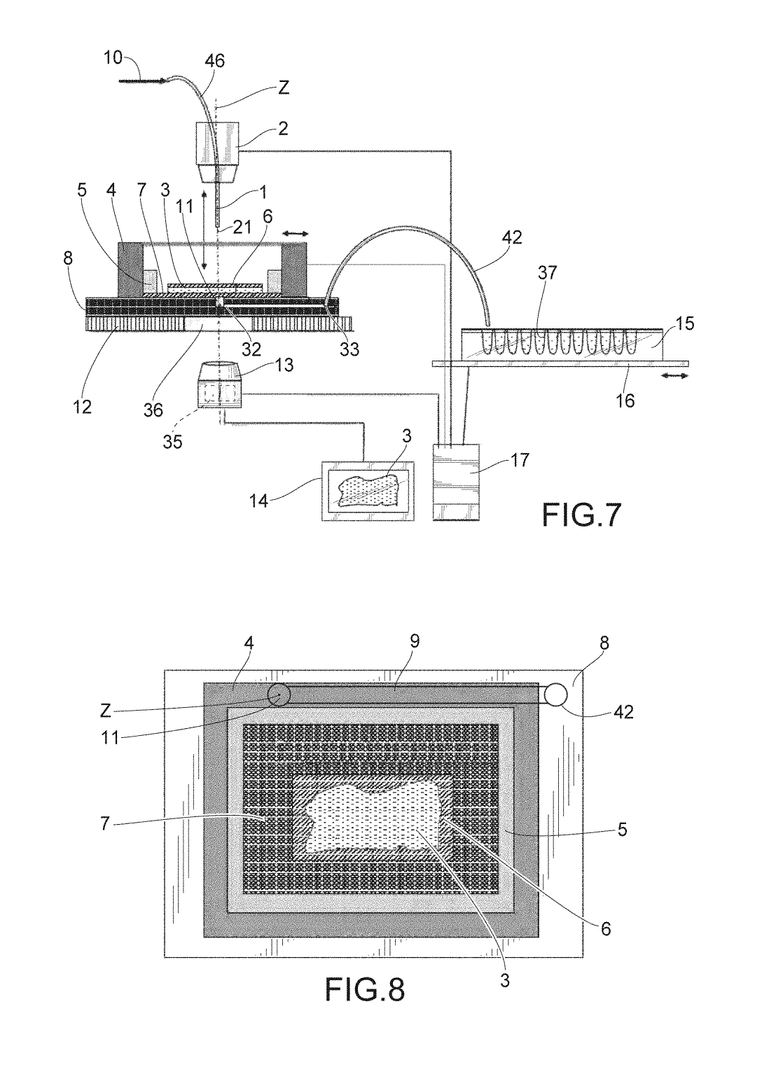

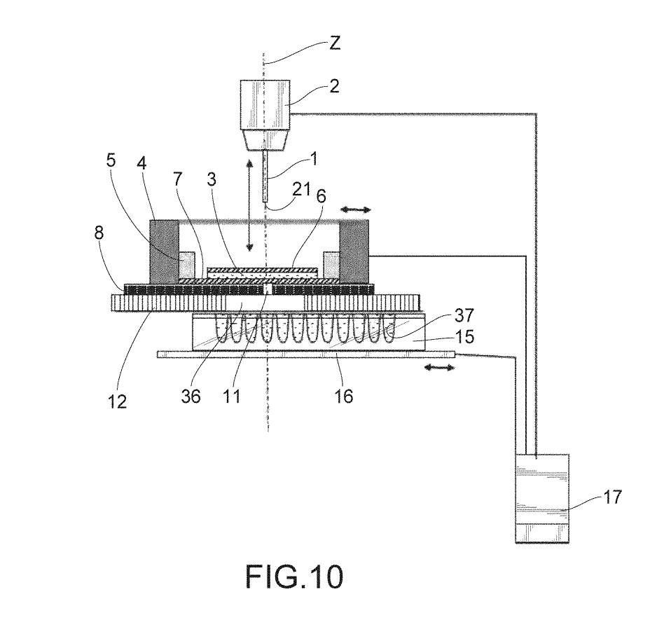

Examples of the present invention are described hereunder with reference to the accompanying FIGS. 1 to 14. The examples described below shall not limit the contents of the invention that are described in the claims. Further, not all configurations shown below are necessarily the essential configurations of the present invention. Here, the up, down, left and right directions in FIG. 1, FIG. 6, FIG. 7, and FIGS. 10 to 14 are described as the up, down, left and right directions of the sample collection system of the invention.

### Example 1

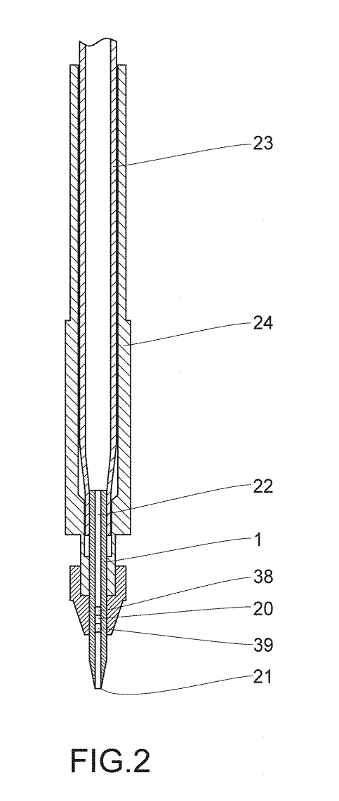

FIG. 1 is a view schematically showing an example of the configuration of the sample collection system of this example. In FIG. 1, “1” represents a collection needle for cutting and collecting a tissue microdissection or cells as a sample 20 from a biological specimen 3, this collection needle 1 can be detachably attached to a collection needle actuation mechanism 2 for moving the collection needle 1 in the vertical direction (direction of Z axis). The collection needle 1 is made of metal such as nickel or stainless steel, and has one end thereof formed into a tapered hollow cylindrical shape. A tip end portion 21 is formed into a cylindrical shape, and has been subjected to a knife edge processing. As shown in FIG. 2, formed inside the collection needle 1 is a needle inner flow path 22 allowing a fluid or the like to flow therethrough. Although the diameter of such needle inner flow path 22 is about 100 μm, it can be appropriately changed. This diameter is 1 to 5,000 μm, 1 to 1,000 μm, or 1 to 500 μm, for example, it may be selected from 1, 5, 10, 20, 30, 50, 100, 200, 500, 1,000, 3,000, and 5,000 μm and the like. Depending on the type of the biological specimen 3, the collection needle 1 may also be made of glass or ceramic. If made of glass, its inner and outer surfaces are coated with a polymer coating film for increasing the strength. Further, it may also be made of a polymer member such as polyglycolic acid (PGA).

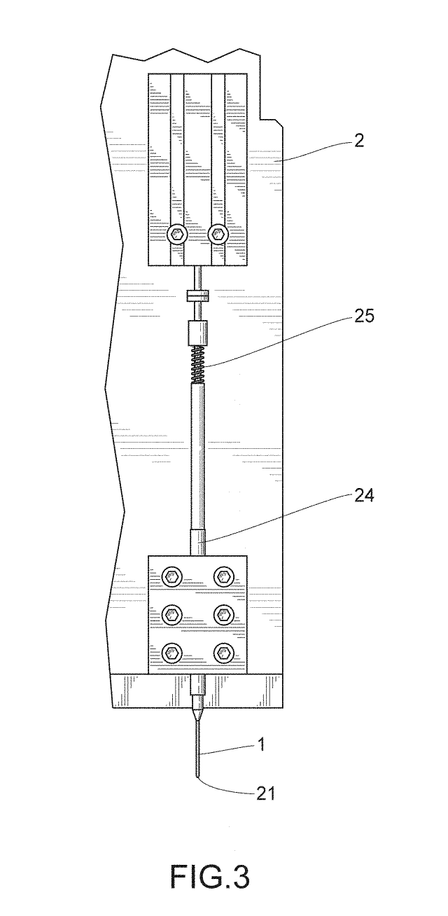

As shown in FIG. 2, a tube 23 is attached to the other end of the collection needle 1, the tube 23 being inserted into a needle housing 24. The inner diameter of the tube 23 is larger than the outer diameter of the collection needle 1. As this tube 23 is made of a synthetic resin having thermal contractility, the other end side of the collection needle 1 can be inserted into the tube 23 to be tightly fixed to the tube 23. The tube 23 is connected to a solution tank (not shown) for storing a solution 10 as a liquid, and the solution 10 ejected from such solution tank by a first pump (not shown) flows into the needle inner flow path 22 of the collection needle 1 via the tube 23. This first pump is capable of sucking a solution 10 remaining in the needle inner flow path 22 and the tube 23. However, instead of providing the above solution tank and first pump, the solution 10 is retained in the collection needle 1. Further, as shown in FIG. 3, the collection needle 1 is fixed to the collection needle actuation mechanism 2 via a coil spring 25. When an external force of a certain level or higher has been applied to the tip end portion 21 by hitting a specimen, the coil spring 25 will contract to protect the collection needle 1 from being damaged. Particularly, there may be used multiple collection needles 1. In such case, the number of later-described microfluidic channels 9, sample collection gates 11 or the like may simply be identical to the number of these collection needles 1. By bundling together multiple collection needles 1, multiple samples 20 can be collected from adjacent sites of the biological specimen 3. Further, instead of using the coil spring 25, the tip end portion 21 of the collection needle 1 can be protected from the damage by stopping in the middle of a holding sheet 7 that is made of a polymer material and has the biological specimen 3 mounted thereon.

The collection needle actuation mechanism 2 has a stepping motor (not shown) built therein, and is capable of moving in the vertical direction within a given range. A highest stop position (initial position) of the collection needle 1 and a lowest stop position thereof are determined in advance. When the collection needle 1 has arrived at the highest stop position or the lowest stop position, the collection needle actuation mechanism 2 will stop.

If necessary, the collection needle actuation mechanism 2 may be equipped with a vibration motor (not shown) to vibrate the collection needle 1 for cutting and/or penetrating a biological specimen easily. Here, the collection needle 1 may also be vibrated by a piezoelectric element. Further, as a method for making the cutting and/or penetration of the biological specimen 3 or the like easy, there may be provided on the collection needle actuation mechanism 2 a structure where the collection needle 1 rotates about the Z axis. As a rotary mechanism of the collection needle 1, there can be considered a mechanism where a cam pin (not shown) is provided on the needle housing 24, and a cam groove (not shown) is provided on a member located on the outer peripheral area of the needle housing 24, thereby allowing the collection needle 1 to move up and down and rotate as the cam pin moves inside the cam groove.

In FIG. 1, “12” represents a base as a base mounting portion of the sample collection system of the invention, and a mounting board 8 is fixed to the upper surface of such base 12. The mounting board 8 is made of a transparent material such as glass, acrylic resin or a silicone resin, and allows the biological specimen 3 to be observed by an inverted microscope 13. Arranged on the upper surface of the mounting board 8 is a specimen holder actuation mechanism 4 capable of sliding on the mounting board 8 in the directions of the X and Y axes. The specimen holder actuation mechanism 4 has a square frame 5 with an upper and lower parts thereof opened.

The specimen holder actuation mechanism 4 has a stepping motor (not shown) built therein, and is capable of moving in the horizontal direction (on the X-Y plane) within a given range for placing a collection site of a specimen on the Z axis by the position information from a controller.

Further, the holding sheet 7 is placed on the mounting board 8 as a holder for holding the biological specimen 3. The holding sheet 7 is made of, for example, polydimethylsiloxane (PDMS) or a silicone rubber thin film having a thickness of about 10 to 50 μm. The biological specimen 3 is placed on the holding sheet 7, and may be covered with a cover film 6 if necessary, so that it can then be sandwiched between the cover film 6 and the holding sheet 7. Since the cover film 6 and the holding sheet 7 adhered weakly to the specimen, the sample 20 together with a part of the cover film 6 can be separable collected by allowing the collection needle 1 to penetrate this sandwiched part. This is especially effective when directly ejecting the collected sample 20 to a reaction chamber 37 of a titer plate 15. Certainly, the same type of configuration may also be applied to a configuration employing the microfluidic channel(s) 9. Meanwhile, the biological specimen 3 can be prevented from falling apart by covering the cover film 6 of a gel-type film having a thickness of about 10 μm. The cover film 6 and the holding sheet 7 are transparent. Adjustments are made such that the tip end portion 21 of the collection needle 1 can penetrate the cover film 6 and the holding sheet 7, and then reach the sample collection gate(s) 11 of the microfluidic channel(s) 9. Here, the cover film 6 can be laid on the both side of the biological specimen.

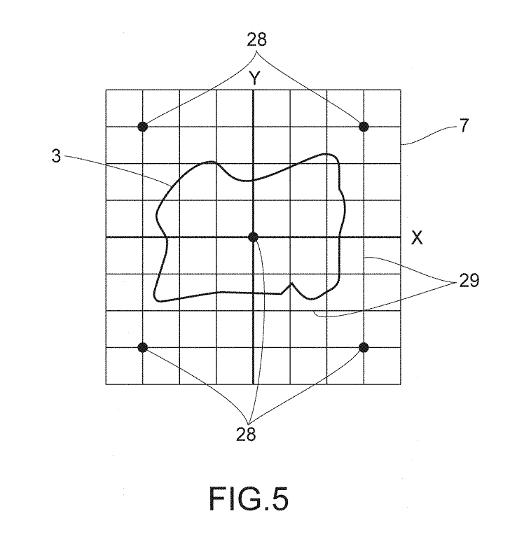

As shown in FIG. 5, provided on the upper or lower surface of the holding sheet 7 are multiple reference points 28 and multiple reference lines 29 representing the coordinate plane (X-Y coordinate plane) of an orthogonal coordinate system, and a collection site of the sample 20 of the biological specimen 3 mounted on the holding sheet 7 can thus be determined as position coordinate information of a position on the two-dimensional coordinates. In this case, an observation device (not shown) other than the sample collection system of the invention may be used to determine a collection site. As the position coordinate information, there may be employed, for example, distances from a center reference point 28 toward the X axis direction and Y axis direction; the position of a point of intersection between the reference lines 29; and the position of an area surrounded by the reference lines 29.

After attaching a frame 5 with a specimen holder to the specimen holder actuation mechanism 4, the coordinate information of a collection site described with the specimen holder coordinates on this holding sheet 7 needs to be transformed to the corresponding coordinate information of the specimen holder actuation mechanism 4 (actuation mechanism coordinates). This coordinate conversion is carried out by using the above observation device to observe and measure the coordinates of collection sites together with the several reference points 28 on the holding sheet 7, the corresponding coordinates of the specimen holder actuation mechanism 4 are known. The position information as the two-dimensional coordinates of a collection site on a specimen placed in the specimen holder actuation mechanism 4 with the holding sheet 7 adhering to the frame 5 is obtained by the above coordinate conversion, and is then stored in a memory device 30 built in a control unit 17. Next, when the position coordinate information of a collection site described in the specimen holder coordinates on the holding sheet 7 has been supplied to the control unit 17 via the controller 27, the position information described in the actuation mechanism coordinates corresponding to the position coordinate information described in the specimen holder coordinates that has been stored in the memory device 30 will be read out. Further, based on the position information read out, a control device 31 sends out a command to the specimen holder actuation mechanism 4 to move a collection site of the biological specimen 3 onto the collecting position (on the Z axis). Here, a collecting position refers to a position at which the collection needle 1 comes down; and a collection site refers to a part of the biological specimen 3 from which the sample 20 is collected.

As for the determination of a collection site of the biological specimen 3, it may be determined before placing the holding sheet 7 in the specimen holder actuation mechanism 4, while conducting observation using a microscope (not shown); or it may be determined after placing the holding sheet 7 in the specimen holder actuation mechanism 4, while conducting observation using the inverted microscope 13. In the former situation, since the determination is carried out based on the reference points 28 and the reference lines 29 that are provided on the holding sheet 7, the position information on the holding sheet 7 is transformed to the information of the coordinates based on the movement of the specimen holder actuation mechanism 4. In the latter situation, a position determined via observation is immediately read as the position coordinates (actuation mechanism coordinates) with regard to the specimen holder actuation mechanism 4.

The holding sheet 7 is to be bonded and fixed to the frame 5 with the biological specimen 3 being sandwiched between such holding sheet 7 and the cover film 6. Here, the biological specimen 3 may be sandwiched by two cover films 6. The frame 5 is formed into the shape of a rectangular cylinder with an upper and lower parts thereof opened, and the bottom surface of such frame 5 is bonded to the holding sheet 7. The frame 5, cover film 6, holding sheet 7 and sample 20 are mounted inside the specimen holder actuation mechanism 4. As the frame 5 is embedded in the specimen holder actuation mechanism 4, the frame 5, cover film 6, holding sheet 7 and sample 20 can come together to slide on the mounting board 8 along with the specimen holder actuation mechanism 4.

The microfluidic channel 9 as a flow path allowing the sample 20 to flow therethrough, is formed inside the mounting board 8 in the horizontal direction. In this example, although the inner diameter of the microfluidic channel 9 is 100 μm, it can be appropriately changed. Further, the microfluidic channel 9 is made of, for example, PDMS, glass or fluorine resin, and is transparent. Particularly, it is desired to form the microfluidic channel 9 as a linear shape for preventing clogging of the sample 20 flowing thereinside.

Formed at one end of the microfluidic channel 9 is a fluidic channel inlet 32 into which the solution 10 is injected; and formed at the other end of the microfluidic channel 9 is a fluidic channel outlet 33 from which the solution 10 and the sample 20 are ejected. Connected to the fluidic channel inlet 32 is a second pump (not shown) for injecting the solution 10 into the microfluidic channel 9, where a given amount of the solution 10 can be ejected into the microfluidic channel 9 for a given period. Here, this second pump can even suck in the solution 10 remaining in the microfluidic channel 9. The first and second pumps operate via a pump actuation mechanism 34, and serve to eject and suck in the solution 10. Here, the solution 10 and the sample 20 that have been ejected from the collection needle 1 into the microfluidic channel 9 may be carried to the titer plate 15 as a storage portion using air flow.

Formed on the mounting board 8 is the sample collection gate 11 as a through hole that is vertically formed from the upper surface thereof toward the microfluidic channel 9. The sample collection gate 11 is arranged on the same axis as the Z axis serving as the central axis of the collection needle 1, and the inner diameter of the sample collection gate 11 is formed larger than the outer diameter of the tip end of the collection needle 1. Thus, the tip end portion 21 of the collection needle 1 can be inserted into the sample collection gate 11 as the collection needle 1 comes down.

Arranged in a lower space of the base 12 are the inverted microscope 13 and a video camera 35 as observation devices. The biological specimen 3 and the holding sheet 7 that are observed by the inverted microscope 13 are captured by the video camera 35, and the captured images are then displayed on a monitor 14 connected to the video camera 35. An observation hole 36 as a through hole is formed on the base 12; and the mounting board 8, microfluidic channel 9, cover film 6 and holding sheet 7 are made of transparent materials. Thus, the biological specimen 3 can be observed from underneath with the inverted microscope 13.

The titer plate 15 for storing the sample 20 collected, is provided in the vicinity of the fluidic channel outlet 33. There are 96 reaction chambers 37 on the titer plate 15. The titer plate 15 is detachably attached to a storage portion actuation mechanism 16. The storage portion actuation mechanism 16 can move within a given range via a stepping motor (not shown) built therein, and can move each reaction chambers 37 to a position facing the fluidic channel outlet 33 in a way such that the solution 10 and sample 20 ejected from the outlet 33 can be reliably stored in the reaction chambers 37. Further, the fluidic channel outlet 33 may be connected to a sample preparation system (not shown) for analyzing or examining the sample 20, and the sample 20 may thus be carried to the sample preparation system. Here, the number of the reaction chambers 37 provided on the titer plate 15 can be appropriately changed.

As the solution 10, there may be employed an oil; or there may be employed a buffer solution. If using an oil, the solution 10 and the sample 20 are recovered as liquid droplets. At that time, the oil may, for example, be a fluorine-based inert liquid, a mineral oil or a silicone oil; or an oil to which a surfactant has been added if necessary, or even a mixture of one or more kinds of oils. Further, the buffer solution may be a buffer solution often used in experiments involving cells, such as PBS; or such buffer solution may be used in combination with an RNA-stabilizing solution such as RNA later (registered trademark in USA), RNA Save (trademark) and Cell cover (trademark) for the purpose of stabilizing RNA. In contrast, if using the buffer solution, substances derived from cells destroyed by cutting the biological specimen 3, for example, will be dispersed in the solution 10, and only the sample 20 being a large block can be recovered. That is, the solution 10 can be appropriately selected based on how the sample 20 is to be prepared.

Here, a sequence of steps from collecting the sample 20 to the recovery thereof is described. In the beginning, the biological specimen 3 is placed on the holding sheet 7, followed by covering it from above with the cover film 6 to sandwich the biological specimen 3 therebetween. This holding sheet 7 is then fixed to the bottom surface of the frame 5, followed by placing the frame 5 in the specimen holder actuation mechanism 4, and then mounting the specimen holder actuation mechanism 4 on the mounting board 8. Particularly, the holding sheet 7 may be fixed to the frame 5 in advance. A collection site of the biological specimen 3 is determined while observing the image of the biological specimen 3 that is displayed on the monitor 14. By inputting the position information of such collection site determined via the controller 27, the specimen holder actuation mechanism 4 will move on the X-Y plane (horizontal direction) such that the collection site will be positioned on the Z axis (collection position). Further, the reaction chamber 37 for storing the sample 20 will be selected, and the storage portion actuation mechanism 16 will move the titer plate 15 so as that the predetermined reaction chamber 37 will be positioned to face the fluidic channel outlet 33 of the microfluidic channel 9. When the collection site has been positioned on the Z axis, the collection needle 1 comes down to cut as well as penetrate the cover film 6, biological specimen 3 and holding sheet 7. Then there will be collected in the needle inner flow path 22 from above a fragment 38 of the cover film 6, the sample 20 and a fragment 39 of the holding sheet 7, as shown in FIG. 2. The collection needle 1 penetrates the holding sheet 7, and stops when the tip end portion 21 thereof has been inserted into the sample collection gate 11. Once the collection needle 1 has stopped, the solution 10 reserved in the abovementioned solution tank will be injected into the needle inner flow path 22, and the sample 20 and the fragments 38, 39 inside the collection needle 1 will be ejected into the microfluidic channel 9 by an injection pressure of the solution 10. Later, the solution 10 will be ejected into the microfluidic channel 9 by the second pump, and the sample 20 as well as the fragments 38, 39 will then travel in the microfluidic channel 9 before being ejected from the fluidic channel outlet 33, and flowing into the reaction chamber 37. The collection needle 1 will return to the initial position after discharging the sample 20 and the fragments 38, 39. In a case where multiple collection sites in the biological specimen 3 are determined, and the position information of these multiple collection sites is then supplied to the control unit 17, the aforementioned sequence of steps will be repeated for as many times as the number of the collection sites. Here, the collection of the sample 20 may be performed by determining multiple collection sites via observation of the biological specimen 3, and then successively carrying out collection; or by determining a collection starting point, and then automatically and successively carrying out collection at a given interval along the X and Y axes, or from multiple collection sites within the X-Y plane. In such case, there is an advantage of saving the time for determining a collection site(s) via observation of the biological specimen 3.

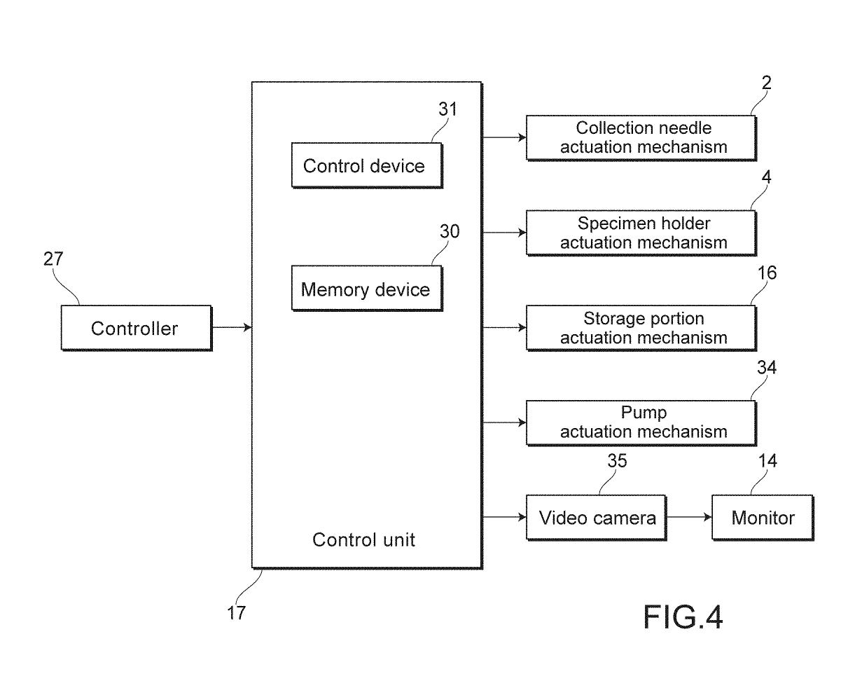

FIG. 4 shows an electrical structure of the sample collection system of the present example. In this diagram, the controller 27 is connected to an input port of the control unit 17; and connected to an output port of the control unit 17 are the collection needle actuation mechanism 2, the specimen holder actuation mechanism 4, the storage portion actuation mechanism 16, the pump actuation mechanism 34 and the video camera 35. The monitor 14 is connected to the video camera 35 to display the images captured by the video camera 35.

The electrical structure in the sequence of the steps from collecting the sample 20 to the recovery thereof is described. When the sample collection system of the invention is turned on by the controller 27, the command from the control device 31 will cause the video camera 35 to capture the image observed by the inverted microscope 13, and then display it on the monitor 14. After fixing the biological specimen 3-mounted holding sheet 7 to the frame 5, and placing such fame 5 in the specimen holder actuation mechanism 4, the image of the biological specimen 3 will be displayed on the monitor 14. After a collection site has been determined by a cursor on the monitor, the position information of the collection site will be stored in the memory device 30 as the position information in the specimen holder actuation mechanism 4 (described in actuation mechanism coordinates). Based on this position information, a command signal from the control device 31 causes the storage portion actuation mechanism 16 to operate in a way such that the titer plate 15 moves to place a predetermined reaction chamber 37 at a position facing the fluidic channel outlet 33. A command signal from the control device 31 moves the specimen holder actuation mechanism 4 to place the collection site on the Z axis (collection position). When the movement of the specimen holder actuation mechanism 4 stops, a command signal from the control device 31 causes the collection needle actuation mechanism 2 to move the collection needle 1 down. Here, the lowest position of the collection needle 1 is determined and stored in the memory device 30 in advance. The collection needle 1 stops when the tip end portion 21 has been inserted into the sample collection gate 11, and then the solution 10 can be ejected into the tube 23 from the first pump. As the first pump for ejecting the solution 10, various types of embodiments are available. For example, a plunger in a syringe-shaped tool in which the solution 10 is reserved may be pressurized by a compressor or the like, or a solenoid or the like. Here, a mechanism for refilling the solution tank with the solution 10 may also be provided on such solution tank in which the solution 10 is reserved. Once the sample 20 and the fragments 38, 39 have been ejected into the microfluidic channel 9, the ejection of the solution 10 from the first pump stops, and the solution 10 starts to be ejected from the second pump into the microfluidic channel 9. Particularly, as described above, an oil and air may also be ejected from the second pump. Further, the collection needle 1 returns and then stops at the initial position. Once the sample 20 and the fragments 38, 39 have been ejected from the fluidic channel outlet 33, a command signal will be sent from the control device 31 to the pump actuation mechanism 34 to stop ejecting the solution 10 from the second pump, and thus complete one cycle of the collection process of the sample 20. Here, the ejection of the solution 10 may be finished after the solution 10 was ejected for a given period in accordance with the length of the microfluidic channel 9. In a case where the setup is such that multiple collection sites are determined by the controller 27, and that collection is carried out in a successive manner, the sample 20 and the fragments 38, 39 are ejected from the fluidic channel outlet 33, and a command signal from the control device 31 causes the storage portion actuation mechanism 16 to move a reaction chamber 37 that will store the next sample 20 at a position facing the fluidic channel outlet 33, thereby enabling a second and subsequent rounds of the collection of the sample 20.

The collection needle actuation mechanism 2 reciprocates within a given range, and stops at a predetermined position. The moving range of the specimen holder actuation mechanism 4 is narrower than those of the collection needle actuation mechanism 2 and the storage portion actuation mechanism 16. A collection site in the biological specimen 3 needs to be precisely positioned on the Z axis, and a fine moving step is thus required for the purpose. The storage portion actuation mechanism 16 needs to move in a wide range, but travels shorter distances when moving between the adjacent reaction chambers 37. Thus, the actuation mechanisms may employ stepping motors with different step angles; or stepping motors with an identical step angle, where the moving distance and moving speed of each actuation mechanism can then be adjusted by setting the pulse numbers input. In fact, a part of or all the collection needle 1, frame 5 and titer plate 15 may be moved manually.

With regard to the nucleic acids, proteins and other biological components in the test sample 20 collected in the reaction chamber 37 using the system of the invention, qualitative or quantitative analyses can be conducted, or gene expression in the test sample 20 of these components can be examined. In order to conduct these analyses and examinations, there may be employed, for example, various analysis and examination methods after disrupting the sample 20 in the reaction chamber 37, and then extracting a test substance(s) therefrom. Further, automatic analyses and examinations are available if combining automatic analysis or examination devices to conduct these analyses and examinations. By conducting an automatic analysis or examination, a large number of test samples can be analyzed or examined rapidly.

The disruption of the sample 20 is performed by, for example, disrupting the cells by means of an enzyme, a surfactant or the like after storing the sample 20 in the reaction chamber 37. Instead, the sample 20 in the reaction chamber 37 may also be immediately frozen and stored. Disruption may be performed after homogenizing the sample 20 in the frozen state using a pestle or the like; or the sample 20 may be disrupted after putting the sample 20 into a solution containing, for example, a medical agent for inhibiting the degradation of the sample 20 collected, and then test compounds, nucleic acids, peptides or proteins; or their fragments are extracted from the homogenized sample 20 for analysis or examination.

As methods for analyzing the components in the biological sample 20, and methods for examining the expression of the nucleic acids and proteins in the sample 20, there may be employed chromatography analysis, antigen-antibody reaction, RT-PCR, cDNA microarray, whole genome sequencing, exome sequencing, targeted resequencing, methylated sequencing, ChIP.Seq, gene expression analysis by whole cDNA sequencing, Small RNA analysis, Western blotting, Northern blotting, Southern blotting, protein chip analysis and mass analysis.

As a chromatography analysis, there may be employed, for example, high performance liquid chromatography (HPLC), gas-liquid chromatography (GLC), high performance thin layer chromatography (HPTLC), high-performance liquid chromatography-mass spectrometry (LC-MS) and gas chromatography-mass spectrometry (GC-MS).

Analysis or examination methods utilizing antigen-antibody reactions include, for example, immune tissue staining (including fluorescence staining), FACS (flow cytometry), immunoblotting, dot-blotting, ELISA and RIA.

Further, by using RT-PCR, the nucleic acids in the sample 20 can be analyzed, the expression thereof can be examined. The nucleic acids that are analyzed and examined include, but are not limited to genome DNA, messenger RNA (mRNA), noncoding RNA (ncRNA), microRNA and their fragments. As RT-PCR, there may be employed normal RT-PCR or real-time RT-PCR. A nucleic acid(s) is separated by disrupting the sample 20 in the reaction chamber 37; and there can be produced a nucleic acid library by fixing to a solid-phase support such as a resin or beads the nucleic acid(s) that has been separated; or a nucleic acid having an sequence identical or complementary to that of the nucleic acid separated, such as cDNA. By analyzing the nucleic acid(s) in this nucleic acid library via real-time RT-PCR, it is possible to analyze one or more kinds of gene expression conditions in the sample 20. As a method for obtaining more detailed information, whole genome sequencing or whole transcriptome (mRNA) sequencing can also be performed with a large-capacity DNA sequencer.

Further, by utilizing, for example, cDNA micro array, exome sequencing, target resequencing, methylation sequencing, Western blotting, Northern blotting, Southern blotting and protein chip analysis, it is possible to analyze, for example, the expression level of proteins and genes related to diagnoses of diseases, and biomarkers such as SNPs.

These operations can also be performed with the above sample preparation system, after carrying to this sample preparation system the sample 20 that has been collected in the reaction chamber 37.

Particularly, these extraction or separation method of the sample 20, analysis method, examination method and the method for producing the cDNA library, for example, can be carried out according to methods known to those skilled in the art (e.g. WO2006/112400, WO2007/139224, WO2013/125141, WO2015/008320, and Japanese Unexamined Patent Application No. 2007-312098).

In addition, using the sample 20 collected in the reaction chamber 37 with the system of the invention, it can be applied to, for example, screening of an agonist or antagonist corresponding to a particular receptor present on the cell membrane, screening of peptides, receptor screening, and screening of cancer cells. As a result of automatizing these screening methods, high-throughput screenings are possible. Applications to these screenings can be conducted according to methods known to those skilled in the art (Japanese Unexamined Application No. 2010-29178).

The aforementioned analyses or examinations allow the invention to be applied to the diagnoses of diseases contacted by human or animals from which the test sample(s) 20 has been collected; predictions of possible future diseases contracted or developed, or the probabilities thereof; prevention of various diseases, or screenings of therapeutic medicine for various diseases; and analyses of expressed genes in each one of the cells of an animal or plant specimen.

As described above, the sample collection system of the present example includes one or multiple hollow collection needles 1 for collecting the sample 20 from the biological specimen 3; and a solenoid 87 allowing the solution 10 to flow into the collection needle 1. The solution 10 is ejected from the collection needle 1 together with the sample 20, and the sample 20 is then recovered. That is, the solution 10 allows the sample 20 collected to be discharged from the collection needle 1, and is capable of washing the inner side of the collection needle 1. Therefore, there is no need to wash the inner side of the collection needle 1 by removing it every time after a cycle of the collection of the sample 20 is completed, and the sample(s) 20 can thus be collected in a successive manner. In this way, in a case where multiple samples 20 are to be collected, the collection time can be shortened.

Further, the sample collection system of the present example includes the holding sheet 7 to hold the biological specimen 3 and capable of being cut and penetrated by the collection needle 1; the frame 5 for holding the holding sheet 7; the mounting board 8 for mounting the frame 5; the collection needle actuation mechanism 2 for moving the collection needle 1 in one axis direction at the time of collecting the sample 20; and the specimen holder actuation mechanism 4 for moving the frame 5 on a plane orthogonal to the abovementioned one axis direction, and the collection needle 1 collects the sample 20 by cutting the biological specimen 3. In this way, the sample(s) 20 can be rapidly collected from the biological specimen 3 in a repetitive manner.

Furthermore, the sample collection system of the present example includes the titer plate 15 for storing the sample 20; and the storage portion actuation mechanism 16 for moving the titer plate 15 in at least one axis plane direction orthogonal to the abovementioned one axis direction, and the titer plate 15 includes multiple reaction chambers 37 for storing the sample(s) 20. In this way, the sample(s) 20 collected can be separately stored in the reaction chambers 37.

Furthermore, the sample collection system of the present example includes one or multiple microfluidic channels 9 allowing the solution 10 to flow therethrough together with the sample 20 inside the microfluidic channel(s) 9. In this way, the sample 20 collected can be efficiently carried to an arbitrary location.

Furthermore, in the sample collection system of the present example, the microfluidic channel 9 is provided below the holding sheet 7, and the tip end portion 21 of the collection needle 1 is to be arranged in the upper region of the microfluidic channel 9 to discharge the sample 20 from the tip end portion 21 of the collection needle 1 to the microfluidic channel 9.

Furthermore, in the sample collection system of the present example, the tip end portion 21 of the collection needle 1 can be reliably inserted into the microfluidic channel 9, or the sample collection gate 11 joined to the microfluidic channel 9. In this way, the sample 20 can be reliably discharged from the collection needle 1 into the microfluidic channel 9.

Furthermore, the sample collection system of the present example includes the sample preparation system for analyzing or examining the sample 20, and the microfluidic channel 9 or the collection needle 1 is connected to the sample preparation system. In this way, the sample 20 can be directly carried to the sample preparation system.

Furthermore, in the sample collection system of the present example, since the sample 20 can be ejected from the tip end portion 21 of the collection needle 1 together with the solution 10, the sample 20 can be easily discharged from the inner side of the collection needle 1.

Furthermore, the sample collection system of the present example includes the inverted microscope 13 for observing the biological specimen 3 and the video camera 35, and a collection site of the biological specimen 3 is determined based on the image information obtained via the inverted microscope 13 and the video camera 35. In this way, the collection site can be easily determined while visually observing the biological specimen 3. Also, by determining a collection starting position, the sample(s) 20 can then be automatically and successively collected from multiple collection sites that are designated at a given interval.

Furthermore, in the sample collection system of the present example, provided on the holding sheet 7 are the reference points 28 and reference lines 29 for identifying positions on the two-dimensional coordinates. That is, the coordinates of the collection sites are determined based on these reference points 28 and reference lines 29. In this way, a collection site in the biological specimen 3 can be easily identified. Here, a position in the video image is linked to the coordinates of the specimen holder actuation mechanism 4, which allows the collection site to be determined on the image.

Furthermore, in the sample collection system of the present example, it is possible to transform the two-dimensional coordinates of the holding sheet 7 into the two-dimensional coordinates of the frame 5 or the two-dimensional coordinates of the specimen holder actuation mechanism 4 (actuation mechanism coordinates). With the same transformation, the coordinates of a collection site with respect to the holding sheet 7 can be easily transformed into the coordinates of the collection site with respect to the frame 5 or the actuation mechanism coordinates. In addition, by leaving a positional marker on the holding sheet 7, the two-dimensional coordinates of the holding sheet 7 can be transformed into the two-dimensional coordinates of the frame 5 or the two-dimensional coordinates of the specimen holder actuation mechanism 4. Thus, the coordinates of a collection site with respect to the holding sheet 7 can be easily transformed to the coordinates of the collection site with respect to the frame 5 or the actuation mechanism coordinates. This makes it possible to observe the biological specimen 3 with an observation system other than the sample collection system of this example, for determining a collection site so as to install the position information thereof described in the actuation coordinates as well as the biological specimen 3 in the sample collection system of the present example, and then automatically collect the sample 20.

Furthermore, with regard to the sample collection system of the present example, the biological specimen 3 can be tissue materials, cells, cell groups, cells dispersed and held on a sheet, cell groups dispersed and held on a sheet, or cell groups trapped in a micro-chamber array or the like. Thus, the sample(s) 20 can be repeatedly and rapidly collected from tissue materials, cells, cell groups, cells dispersed and held on a sheet, cell groups dispersed and held on a sheet.

Furthermore, with regard to the sample collection system of the present example, the biological specimen 3 can be selected from tissue slices or cells. Thus, tissue slices or cells can be collected as the sample 20.

Furthermore, in the sample collection system of the present example, the tip end portion 21 of the collection needle 1 has the cylindrical shape, thereby making it possible to easily cut and penetrate the biological specimen 3.

Furthermore, in the sample collection system of the present example, the collection needle 1 is made of a metal, glass, a material with a polymer coating film formed on a glass surface, or a polymer material, thereby making it possible to easily cut and penetrate the biological specimen 3.

### Example 2

FIG. 6 schematically shows a second example of the present invention. Elements identical to those in the first example are given identical symbols, and the detailed explanations thereof are thus omitted in the detailed description below. In the present example, a first capillary tube 41 as an ultrathin tube is connected to the fluidic channel inlet 32 of the microfluidic channel 9, and a second capillary tube 42 also as an ultrathin tube is connected to the fluidic channel outlet 33. The second pump is connected to the first capillary tube 41, and the pump actuation mechanism 34 allows a given amount of the solution 10 to be ejected into the first capillary tube 41 for a given period of time. Particularly, this second pump is capable of sucking in the solution 10 remaining in the first capillary tube 41, microfluidic channel 9 and second capillary tube 42. The tip end of the second capillary tube 42 is arranged in proximity to the reaction chamber(s) 37, which allows the sample 20 to be reliably discharged into the reaction chamber(s) 37. Further, the second capillary tube 42 may also be connected to the aforementioned sample preparation system, and the sample 20 may thus be carried to such sample preparation system. Here, an oil or air may be ejected from the second pump, whereas the sample 20 and the fragments 38, 39 as well as the solution 10 may be carried to the titer plate 15.

The first capillary tube 41 and the second capillary tube 42 are made of a flexible synthetic resin. However, glass-made capillary tubes may also be used.

In the present example, once the sample 20 and the fragments 38, 39 have been ejected from the needle inner flow path 22 into the microfluidic channel 9, a command signal from the control device 31 will cause the pump actuation mechanism 34 to operate so that the solution 10 can then be ejected from the second pump into the first capillary tube 41. The sample 20 and the fragments 38, 39 will flow inside the microfluidic channel 9 and the second capillary tube 42 together with the solution 10, before being discharged into the reaction chamber(s) 37.

### Example 3

FIG. 7 schematically shows a third example of the present invention. Elements identical to those in the first and second examples are given identical symbols, and the detailed explanations thereof are thus omitted in the detailed descriptions below. In the present example, a third capillary tube 46 as an ultrathin tube is connected to the other end side of the collection needle 1, the fluid channel inlet 32 and the sample collection gate 11 are jointed together, and the second capillary tube 42 is connected to the fluid channel outlet 33. The first pump is connected to the third capillary tube 46, and a given amount of the solution 10 is capable of being ejected into the third capillary tube 46 for a given period of time. This first pump can suck in the solution 10 remaining in the third capillary tube 46 and the needle inner flow path 22. The third capillary tube 46 is made of a flexible synthetic resin; and even when the collection needle actuation mechanism 2 moves, the third capillary tube 46 will deform in accordance with the movement of the collection needle actuation mechanism 2 such that the third capillary tube 46 can be prevented from being easily disengaged from the first pump 1.

In the present example, the collection needle 1 collects the sample 20, and then once the collection needle 1 has stopped at a position where the tip end portion 21 is already inserted into the sample collection gate 11, a command signal from the control device 31 will activate the pump actuation mechanism 34 such that the solution 10 will be ejected into the third capillary tube 46 by the first pump, and then flow in the needle inner flow path 22 before being discharged into the microfluidic channel 9 together with the sample 20 and the fragments 38, 39. The solution 10 will keep being ejected thereafter, and the sample 20 and the fragments 38, 39 will flow inside the microfluidic channel 9 and the second capillary tube 42 before being discharged into the reaction chamber 37. Once the sample 20 and the fragments 38, 39 have been discharged into the reaction chamber 37, a command signal from the control device 31 will cause the pump actuation mechanism 34 to stop so as to stop ejecting the solution 10. Thus, even after the sample 20 and the fragments 38, 39 have been ejected from the needle inner flow path 22, the collection needle 1 will not rise. However, after the sample 20 and the fragments 38, 39 have been discharged into the reaction chamber 37, a command signal from the control device 31 will activate the collection needle actuation mechanism 2 to return the collection needle 1 to the initial position.

The collection needle 1 stops when inserted into the sample collection gate 11 after penetrating the holding sheet 7. Thus, the needle inner flow path 22 is joined to the microfluidic channel 9 under such condition, and constitutes a part of the microfluidic channel 9.

Here, the second capillary tube 42 may also be connected to the sample preparation system, and the sample 20 may thus be carried to the sample preparation system.

In the present example, since the solution 20 flows in the needle inner flow path 22, the inner region of the needle inner flow path 22 can be washed by the solution 20, thereby requiring no time and effort to detach the collection needle 1 from the collection needle actuation mechanism for cleaning up.

As described above, in the sample collection system of the present example, the collection needle 1 constitutes a part of the microfluidic channel 9, thereby allowing the solution 10 to flow in the collection needle 1, and thus wash the inner region of the collection needle 1.

### Examples 4

FIG. 8 schematically shows a fourth example of the present invention. Elements identical to those in the first to third examples are given identical symbols, and the detailed explanations thereof are thus omitted in the detailed descriptions below. Particularly, FIG. 8 shows the mounting board 8 and others from above. In the present example, the microfluidic channel 9 is arranged on the frame of the specimen holder actuation mechanism 4. When recovering the sample 20, the sample collection gate 11 joined to the microfluidic channel 9 will be positioned on the Z axis, and this state is regarded as the origin position of the specimen holder actuation mechanism 4. After the sample 20 was collected, the collection needle 1 will return to the origin position, and then come down so as to eject the sample 20 into the sample collection gate 11.

The microfluidic channel 9 is arranged in the specimen holder actuation mechanism 4 in this example. However, a bridge-shaped fluidic channel platform (not shown) may be disposed on the upper portion of the specimen holder actuation mechanism 4 so that the microfluidic channel 9 can be arranged inside such fluidic channel platform, and that the sample collection gate 11 can then be formed on the upper surface of this fluidic channel platform. In such case, the fluidic channel platform moves as needed so that the sample 20 can be ejected into the sample collection gate 11, and then be recovered through the microfluidic channel 9.

Once the position information of a collection site has been input via the controller 27, a command signal from the control device 31 will cause the specimen holder actuation mechanism 4 to move the collection site onto the Z axis. After the specimen holder actuation mechanism 4 has stopped moving, a command signal from the control device 31 will activate the collection needle actuation mechanism 2. In this way, the collection needle 1 will come down to collect the sample 20 and the fragments 38, 39. The collection needle 1 will return to its initial position and stop there. After the collection needle 1 has stopped at the initial position, the specimen holder actuation mechanism 4 can return to the origin position and stop there. After the specimen holder actuation mechanism 4 has stopped moving, the collection needle 1 comes down, and then stops once the tip end portion 21 has been inserted into the sample collection gate 11. After the collection needle 1 has stopped, the solution 10 flows from the first pump into the tube 23. Simultaneously, the sample 20 and the fragments 38, 39 are discharged from the sample collection gate 11 into the microfluidic channel 9 together with the solution 10. The solution 10 will keep being ejected thereafter, and the sample 20 and the fragments 38, 39 will flow in the microfluidic channel 9 and the second capillary tube 42 before being discharged into the reaction chamber 37. After the sample 20 and the fragments 38, 39 have been discharged into the reaction chamber 37, the pump actuation mechanism 34 stops the ejection of the solution 10.

By placing the microfluidic channel 9 and the sample collection gate 11 in the specimen holder actuation mechanism 4, only the mounting board 8 can be arranged between the biological specimen 3 and the inverted microscope 13. Since the refractive indexes of the mounting board 8, the microfluidic channel 9 and the sample collection gate 11 are different from one another, the overlapping of the microfluidic channel 9 and/or the sample collection gate 11 with the biological specimen 3 in the vertical direction may prevent the accurate observation of the biological specimen 3 in the configuration where the mounting board 8, the microfluidic channel 9 and the sample collection gate 11 are positioned between the biological specimen 3 and the inverted microscope 13. In the present example, the microfluidic channel 9 and the sample collection gate 11 are arranged above the biological specimen 3, and the only the mounting board 8 is provided between the biological specimen 3 and the inverted microscope 13, thereby making it possible to precisely observe the biological specimen 3.

Particularly, the microfluidic channel 9 in the present example is fixed inside the specimen holder actuation mechanism 4. However, there may also be employed a configuration where the microfluidic channel 9 is not attached to the specimen holder actuation mechanism 4, but attached to the specimen holder 4 or integrally disposed in an actuation mechanism (not shown) other than the specimen holder actuation mechanism 4. In the configuration, the sample collection gate 11 in the actuation mechanism move onto the Z axis when the sample 20 is ejected from the collection needle 1 into the sample collection gate 11, and the microfluidic channel 9 in the actuation mechanism move out of the Z axis so that the actuation mechanism does not prevent the collection needle to comes down when the collection needle 1 comes down to collect the sample 20. In such case, the microfluidic channel 9 merely needs to reciprocate between two locations which are the position at which the sample collection gate 11 is to be arranged on the Z axis; and the position at which the microfluidic channel 9 does not come into contact with the collection needle 1. In this way, there is no need to precisely control the positions of the microfluidic channel 9 by a stepping motor or the like, and the above actuation mechanism can thus be inexpensive. Further, the second capillary tube 42 may be connected to the sample preparation system, and the sample 20 may then be carried to such sample preparation system. Furthermore, as is the case with the third example, the needle inner flow path 22 in the present example also constitutes a part of the microfluidic channel 9. In the present example, since it is not necessary to provide the sample collection gate 11 on the mounting board 8, a commercially available petri dish may be used instead of the frame 5, and the holding sheet 7 and the biological specimen 3 may thus be placed on such petri dish. In such case, it is desired that the collection needle 1 be configured to be able to stop at an intermediate position of the holding sheet 7. Since the sample 20 is to be placed on the holding sheet 7 through the cover film 6, the collection needle 1 can penetrate the sample 20 and the cover film 6, and then hold them in such collection needle 1.

As described above, in the sample collection system of the present example, there is provided the frame 5 to which the holding sheet 7 is to be attached; the microfluidic channel 9 is provided on the frame 5 or the mounting board 8; there are formed one or multiple sample collection gates 11 that are communicated with the microfluidic channel 9; and the sample collection gate(s) 11 are arranged below the holding sheet 7. In this way, the microfluidic channel 9 will not become a hindrance to observation when observing the biological sample 3 from underneath.

Further, in the sample collection system of the present example, the microfluidic channel 9 is provided above the mounting board 8, thereby allowing a space below the mounting board 8 to be effectively utilized.

### Example 5

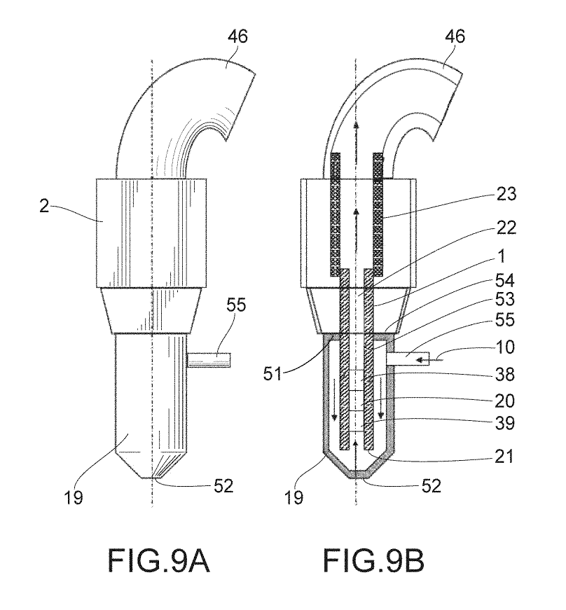

In this example, the sample 20 is not recovered from the tip end of the collection needle 1, but from the opposite side of the collection needle. FIGS. 9A and 9B schematically show a fifth example of the invention; elements identical to those in the first example to the fourth example are given identical symbols, and the detailed explanations thereof are thus omitted in the detailed descriptions below. In these drawings, “19” represents a cover member covering the tip end portion 21 of the collection needle 1. This cover member 19 has a bottomed cylindrical shape, and formed on the upper end portion of such cover member 19 is an attachment portion 51 attaching to the collection needle 1 and the collection needle actuation mechanism 2 in a watertight manner. A lower end portion 52 of the cover member 19 is openable. As a result of opening such lower end portion 52, the collection needle 1 is allowed to move by protruding downward from this opening. An inner diameter surface 53 of the attachment portion 51 abuts against the collection needle 1, and an upper end surface 54 of the attachment portion 51 abuts against the collection needle actuation mechanism 2. Further, attached to the upper portion side surface of the cover member 19 is an injection tube 55 through which the solution 10 is injected into the cover member 19. The third capillary tube 46 is attached to the tube 23 that is attached to the other end side of the collection needle 1, the sample 20 can thus be carried from such third capillary tube 46 to, for example, the storage portion 15 and the sample preparation system. The cover member 19 moves along one or two axis directions, and is detachably attached to the collection needle actuation mechanism 2. Here, the cover member 19 is to be attached to the collection needle actuation mechanism 2 from below the collection needle 1 after the collection needle 1 has collected the sample 20 or the like. Then, such cover member 19 is removed from the collection needle actuation mechanism 2 after the sample 20 or the like has been discharged into the storage portion 15 or the like. In such case, the lower end portion 52 of the cover member 19 does not have to have an openable structure, but a closed structure of such cover member will suffice.

Following is the description of the collection of the sample 20 in the present example. Once the lower end portion 52 of the cover member 19 has opened, the tip end portion 21 of the collection needle 1 will protrude downward from this opening. Later, the collection needle 1 will come down together with the collection needle actuation mechanism 2 to collect the sample 20. After the collection needle 1 and the collection needle actuation mechanism 2 have risen and stopped at their initial positions, the tip end portion 21 of the collection needle 1 will be placed in the cover member 19 before closing the lower end portion 52. Later, the solution 10 will be injected into the cover member 19 from the injection tube 55 such that the solution 10 will then flow into the needle inner flow path 22, and that the injection pressure of the solution 10 will flow the sample 20 through the needle inner flow path 22, the tube 23 and the third capillary tube 46 before being discharged into the storage portion 15 or the like. In the present example, since there is no need to provide the microfluidic channel 9 on the mounting board 8, a space below the mounting board 8 can be effectively utilized. Further, the solution 10 can wash the inner and outer regions of the collection needle 1. Furthermore, the solution 10 may even be configured to flow backward to recover the sample 20.

As described above, in the sample collection system of the present example, the sample 20 is ejected together with the solution 10 from a part of the collection needle other than the tip end portion 21. In this way, the sample 20 collected by the collection needle 1 can be discharged to an arbitrary location.

### Example 6

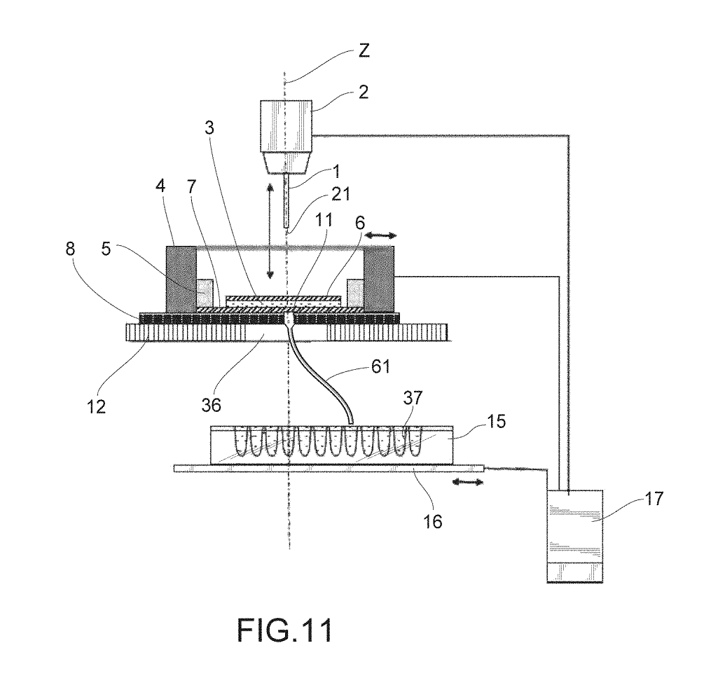

FIG. 10 and FIG. 11 schematically show a sixth example of the present invention. Elements identical to those in the first example to the fifth example are given identical symbols, and the detailed explanations thereof are thus omitted in the detailed descriptions below. In the present example, either the sample 20 is ejected into the reaction chamber 37 from the sample collection gate 11 as shown in FIG. 10; or a fourth capillary tube 61 is to be attached to the lower end of the sample collection gate 11, so that the sample 20 can flow into such fourth capillary tube 61 from the sample collection gate 11, and then be discharged into the reaction chamber 37. In this example, the microfluidic channel 9 is not provided as it is not necessary.

In the present example, the titer plate 15 is arranged below the base 12, which makes it impossible to place the inverted microscope 13 below the base 12. For this reason, it is required that a collection site in the biological specimen 3 should be determined in advance. Such collection site determination is performed by observing the biological specimen 3 with the abovementioned microscope, and then determining a site at which the sample 20 is to be collected. Once the information on a collection site has been input by the controller 27, a command signal from the control device 31 will activate the storage portion actuation mechanism 16 such that the titer plate 15 will move to position a given reaction chamber 37 on the Z axis. Here, in the case where the fourth capillary tube 61 is attached to the sample collection gate 11, the reaction chamber 37 will be arranged at a position facing the outlet of the fourth capillary tube 61. Once the titer plate 15 has stopped moving, the collection needle 1 comes down to cut as well as penetrate the cover film 6, the biological specimen 3 and the holding sheet 7. The collection needle 1 stops while still penetrating the holding sheet 7. Once the collection needle 1 has stopped, the pump actuation mechanism 34 ejects the solution 10 from the first pump into the needle inner flow path 22, and the sample 20 collected as well as the fragments 38, 39 are discharged into the reaction chamber 37. After the discharge of the sample 20 the collection needle 1 returns to and stops at the initial position. Here, the fourth capillary tube 61 may be connected to the sample preparation system, and the sample 20 may thus be carried to such sample preparation system.

In a case where multiple collection sites are determined, and the collections are performed in a successive manner, after the collection needle 1 has collected the sample 20 and discharged it into a reaction chamber and returned to the initial position, the storage portion actuation mechanism 16 moves the titer plate 15 to move horizontally such that a reaction chamber 37 for storing the next sample 20 to be collected has been positioned on the Z axis.

In the present example, instead of the titer plate 15, there may also be used a recovery holder (not shown) with small collection cells being formed on a thin transparent plate. This recovery holder is to be placed below the mounting board 8, and the sample 20 may thus be discharged into such recovery holder. In such case, the inverted microscope 13 can be arranged below the base 12; and after placing the biological specimen 3 on the mounting board 8, a collection site(s) can be determined via observation using the inverted microscope 13.

The abovementioned recovery holder is an acrylic plate having a thickness of 5 mm, and cells formed with the pitch identical to that of the titer plate 15. Each of these cells is formed into the shape of a circular cone having a diameter of 0.3 to 3.0 mm; a buffer solution of about 2 μl may be put into the cell in advance. When determining a collection site, the observation may simply be conducted by displacing the positions of the cells such that the images can be seen easily. After the collection site(s) has been determined, the sample(s) 20 will be collected in sequence, and then ejected into the cells of the recovery holder. Later, the sample(s) 20 that has been discharged into the recovery holder may simply be transferred to the titer plate 15.

### Example 7

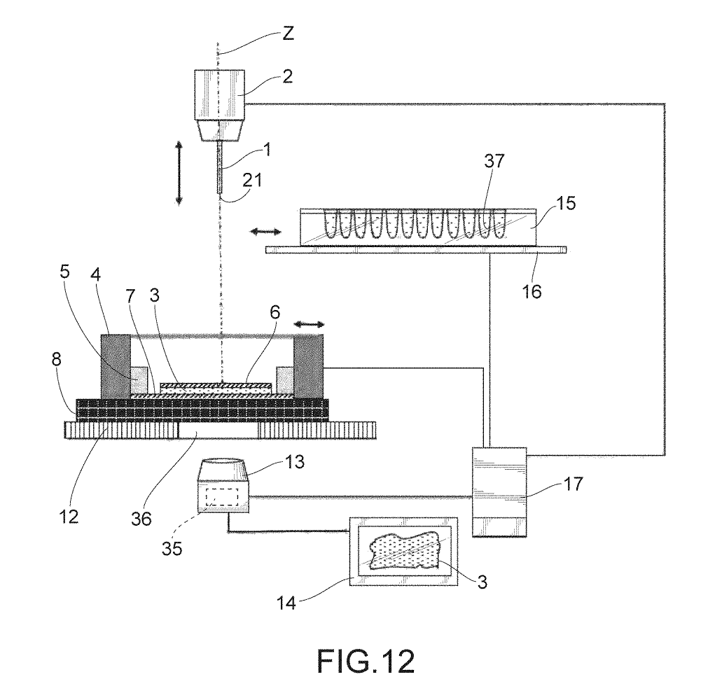

FIG. 12 schematically shows a seventh example of the present invention. Elements identical to those in the first example to the sixth example are given identical symbols, and the detailed explanations thereof are thus omitted in the detailed descriptions below. In the present example, the titer plate 15 will move so as to be positioned under the collection needle 1, thereby allowing the sample 20 collected to be ejected from the collection needle 1 into the reaction chamber 37. The titer plate 15 and the storage portion actuation mechanism 16 stop at a standby position as a position that does not hinder the movements of the collection needle 1 and the collection needle actuation mechanism 2. In the present example, since the sample 20 collected is ejected into the titer plate 15 from the tip end portion 21 of the collection needle 1, the microfluidic channel 9 is not provided as it is not necessary. In the present example, there is no need to provide the sample collection gate 11 on the mounting board 8. Therefore, a commercially available petri dish may be used instead of the frame 5, and the holding sheet 7 and the biological specimen 3 may thus be placed in such petri dish. In such case, there exists a concern that the tip end portion 21 of the collection needle 1 may collide with the petri dish and be damaged after penetrating the holding sheet 7. Thus, adjustments are made such that the collection needle 1 is able to stop at the intermediate position of the holding sheet 7. Further, when placing the biological specimen 3 on the holding sheet 7 together with the cover film 6, the cover film 6, if placed underneath, can be reliably penetrated, which is favorable to the collection of the sample 20.

After a collection site in the biological specimen 3 has been determined, the collection needle 1 comes down to collect the sample 20 and the fragments 38, 39. Then the collection needle 1 returns to the initial position, and the storage portion actuation mechanism 16 moves the titer plate 15 such that a given reaction chamber 37 has been positioned on the Z axis. After the titer plate 15 has stopped moving, the collection needle 1 comes down for the tip end portion 21 to stop above the reaction chamber 37, or to stop after being inserted into the reaction chamber 37. After the collection needle 1 has stopped, the solution 10 is ejected from the first pump into the needle inner flow path 22, and the sample 20 as well as the fragments 38, 39 are discharged into the reaction chamber 37 together with the solution 10. Later, the collection needle 1 returns to and then stops at the initial position. There, the storage portion actuation mechanism 16 will operate to allow the titer plate 15 to move horizontally, and then stop at the standby position. In a case where multiple collection sites are determined, and the samples 20 are then collected in a successive manner, while the samples 20 collected are being discharged into the reaction chamber(s) 37, the specimen holder actuation mechanism 4 operates such that the next collection site can be arranged at the collection position (on the Z axis). Here, when repeating the collection of the sample 20 multiple times, the collection needle 1 and the titer plate 15 do not need to be returned to the standby position, but may simply be stopped at a position where the two do not hinder each other.

As a modified example of the present example, the collection needle actuation mechanism 2 may be moved along the X axis in addition to the Z axis, and the titer plate 15 may be moved along the Y axis. The collection position is set on the Z axis. Further, the titer plate 15 may be fixed, and the collection needle actuation mechanism 2 may be configured to move in the X axis and Y axis directions in addition to the Z axis direction. A moving precision in this case may be that high enough to allow the reaction chamber 37 of the titer plate 15 to be identified. Thus, there can be used a stepping motor (not shown) capable of causing large movements in short periods of time. Even in this case, the collection position is set on the Z axis, and such positional precision can be sufficiently ensured so that there does not exist any practical hindrances. That is, using the specimen holder actuation mechanism 4, the collection site of the biological specimen 3 can be moved to the collection position of the sample 20 with a high accuracy. This is the initial position of the collection needle moving mechanism 2 capable of ensuring the positional precision of the collection needle 1. At this position, the collection needle 1 moves down along the Z axis to collect the sample 20. When recovering the sample 20 collected, the collection needle actuation mechanism 2 moves along the X axis or the X-Y plane, or the reaction chamber 37 of the titer plate 15 moves to the Z axis. If moving the collection needle actuation mechanism 2 on the X-axis or on the X-Y plane, there may also be employed a configuration where the collection needle actuation mechanism 2 moves to a position not hindering the observation of the biological specimen 3 when observing the biological specimen 3, and where the collection needle 1 will then return to the initial position only at the time of performing collection. Since a large collection needle actuation mechanism 2 may hinder the observation, an L-shaped arm 66 in a later-described eighth example may be used so that the collection needle 1 can be held by such L-shaped arm 66. However, the shape of a mechanism for holding the collection needle 1 is not limited to L-shape, but may be any shape. Further, the titer plate 15 may be positioned above, below or at the same level as the mounting board 8. In this way, the system may have a configuration where after the collection needle 1 collects the sample 20, the collection needle 1 and the titer plate 15 are relatively moved such that the sample 20 collected can then be recovered in the reaction chamber 37 together with the solution 10.

Further, as another modified example of the present example, instead of the first pump, there may be used the solenoid 87, a syringe 83 and a reservoir 88 that compose a liquid-inflow mechanism in a later-described ninth example, to allow the solution 10 to flow into the collection needle 1. Methods for using the solenoid 87, the syringe 83 and the reservoir 88 are as described in the ninth example.

As described above, in the sample collection system of the present example, the titer plate 15 moves independently from the frame 5, and is capable of moving faster than the frame 5, thereby making it possible to shorten the time from the collection of the sample 20 to the recovery thereof. Further, a space below the mounting board 8 can be effectively utilized.

Furthermore, the sample collection system of the present example includes a vibration mechanism for vibrating the collection needle 1; and a rotation mechanism for rotating the collection needle 1. The collection needle 1 can thereby be vibrated or rotated, and the biological specimen 3 can thus be easily cut and penetrated.

Furthermore, in the sample collection system of the present example, the titer plate 15 moves independently from the frame 5, and is capable of moving faster than the frame 5, thereby making it possible to shorten the time from the collection of the sample 20 to the recovery thereof.

### Example 8

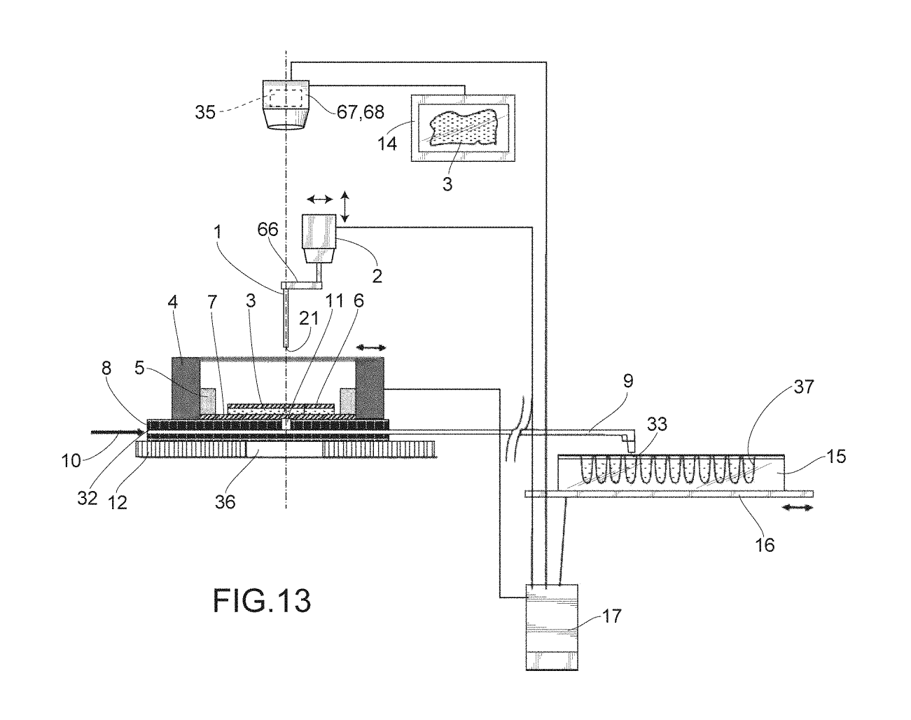

FIG. 13 schematically shows the eighth example of the present invention. Elements identical to those in the first example to the seventh example are given identical symbols, and the detailed explanations thereof are thus omitted in the detailed descriptions below. In the present example, an optical microscope 68 and the video camera 35 are provided above the specimen holder actuation mechanism 4 so that the biological specimen 3 can be observed from above. For this reason, the collection needle actuation mechanism 2 has the L-shaped arm 66 which is arranged in a location deviated from the Z axis so that it will not be a hindrance to the observation of the biological specimen 3. Further, the collection needle 1 is attached to the tip end of the L-shaped arm 66 with a needle housing 24. Furthermore, when observing the biological specimen 3, the L-shaped arm 66 will, for example, move in a direction orthogonal to the Z axis or rotate around the Z axis so that the collection needle 1 will not be a hindrance to the observation. Furthermore, a reference position may also be provided in a location deviated from the collection position; and after adjusting a collection site to such reference position, the specimen holder actuation mechanism 4 will be moved only by a distance from the reference position to the collection position so that the collection site can be positioned at the collection position. Here, as long as the observation of the biological specimen 3 will not be hindered, there shall be no particular restrictions on a mechanism through which the collection needle 1 is to be attached to the collection needle actuation mechanism 2.

In the present example, the biological specimen 3 may be observed from above, using a stereoscopic microscope 67, an upright microscope 68 or the inverted microscope 13. The collection needle 1 stays at a position not hindering the observation at the time of conducting the observation, and a collection site will then be designated by the controller 27 after the collection position of the sample 20 has been determined. Once the collection site has been designated by the controller 27, a horizontal portion of the collection needle 1 will protrude, and a vertical portion will be arranged on the Z axis. The process for collecting the sample 20 thereafter is similar to that of the first example. Here, the fluidic channel outlet 33 may be joined to the sample preparation system, and the sample 20 may thus be carried to such sample preparation system.

As described above, in the sample collection system of the present example, the collection needle 1 is capable of moving in a direction orthogonal to the above one axis direction, thereby allowing the collection needle 1 to be positioned at an arbitrary location.

Further, in the sample collection system of the present example, the collection needle 1 is capable of rotating around an axis parallel to the above one axis, thereby allowing the collection needle 1 to be positioned at an arbitrary location through rotation. The collection needle 1 may also be rotated and then stopped above the reaction chamber 37 so that the sample 20 can then be ejected and recovered.

### Example 9

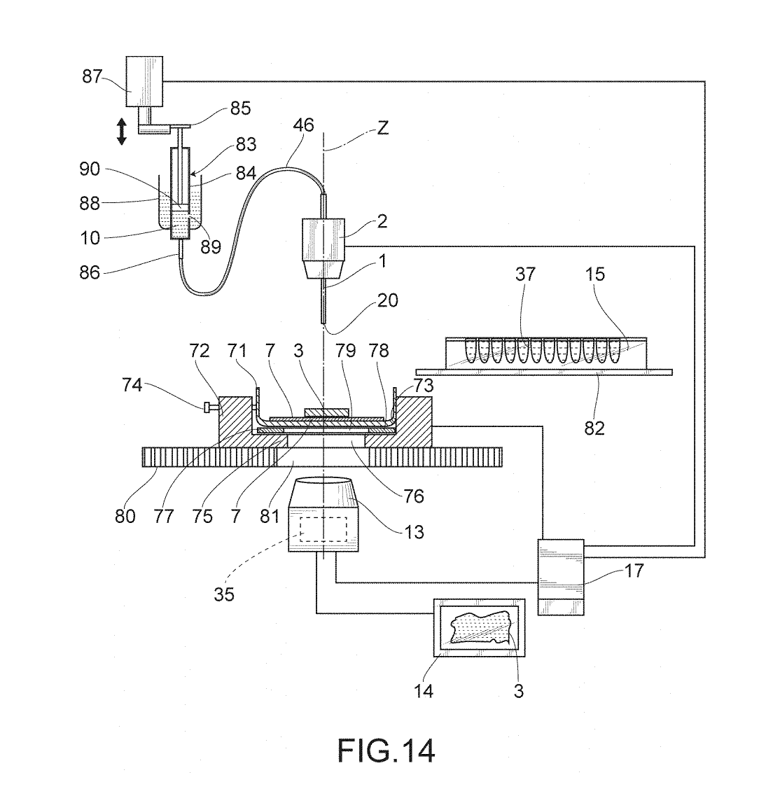

FIG. 14 schematically shows the ninth example of the present invention. Elements identical to those in the first example to the eighth example are given identical symbols, and the detailed explanations thereof are thus omitted in the detailed descriptions below. In the present example, a petri dish 71 is used as a container for placing the biological specimen 3. The petri dish 71 is made of a transparent glass or synthetic resin. As is the case with the holding sheet 7 shown in FIG. 5, there may be provided to the bottom surface of the petri dish 71 two-dimensional coordinates for identifying the position coordinates of a collection site; or the position coordinates may simply be provided to any one of the holding sheet 7 and the petri dish 71. Here, the petri dish 71 may be a normal petri dish that is commercially available.

The petri dish 71 is to be mounted on a petri dish holder 72 as a specimen holder. A mounting groove 73 for mounting the petri dish 71 is formed on the petri dish holder 72. After mounting the petri dish 71 on such mounting groove 73, the petri dish 71 will then be fixed by a fixation pin 74. A bottom hole 76 penetrating the petri dish holder 72 is formed in the central area of a bottom portion 75 of the mounting groove 73. When mounting the petri dish 71 on the mounting groove 73, a protection sheet 78 may be laid between the petri dish 71 and the mounting groove 73 and therefore on an upper surface 77 of the bottom portion 75 if necessary. A sheet hole 79 having a diameter smaller than the bottom hole 76 is formed in the central area of the protection sheet 78. The holding sheet 7 is to be place on the petri dish 71, and the biological specimen 3 is to be placed thereon. Further, if necessary, the biological specimen 3 may be covered by the cover film 6 so that the biological specimen 3 can be sandwiched between the cover film 6 and the holding sheet 7. Alternatively, the biological specimen 3 may be placed on the holding sheet 7 by the intermediary of the cover film 6. By employing a configuration where the tip end portion 21 of the collection needle 1 stops at the intermediate part of the holding sheet though penetrating the cover film 6, the sample 20 can be collected without damaging the tip end portion 21 of the collection needle 1.

The petri dish holder 72 is fixed to the upper surface of a specimen holder actuation mechanism 80, and is capable of moving on the X-Y plane. A sheet hole 79 as a through hole having a diameter larger than that of the bottom hole 76 is formed on the specimen holder actuation mechanism 80. Since the microfluidic channel 9 is not used in the present example, the mounting board 8 is not provided. That is, the petri dish 71 can be observed from underneath through the bottom hole 76 and the sheet hole 79, using the inverted microscope 13; and the petri dish 71 and the holding sheet 7 are transparent. Thus, the biological specimen 3 can be observed using the inverted microscope 13.

The titer plate 15 of the present example is mounted on a storage portion holder 82 in an immovable manner. Since the storage portion actuation mechanism 16 is not provided in this example, the storage portion holder 82 does not move. However, another configuration can be conducted by providing the storage portion actuation mechanism 16, where the titer plate 15 may be mounted on the storage portion actuation mechanism 16 instead of the storage portion holder 82 so that the titer plate 15 can be moved.

In the present example, there is used a syringe 83 for the purpose of allowing the solution 10 to flow into the needle inner flow path 22 of the collection needle 1. The solution 10 is reserved in a barrel 84 of the syringe 83 such that the solution 10 can be ejected from an ejection portion 86 as a tip end portion of a syringe 78 by pushing a plunger 85. The third capillary tube 46 is connected to the ejection portion 86, and the solution 10 ejected from the syringe 83 will flow inside the third capillary tube 46 before flowing into the needle inner flow path 22. The plunger 85 is connected to the solenoid 87 for moving the plunger 85 up and down; and as the plunger 85 reciprocates, the solution 10 can flow into the needle inner flow path 22, and the collected sample 20 in the needle inner flow path 22 can be sucked in. When discharging the collected sample 20, the solenoid 87 will push the plunger 85 downward so that the solution 10 can be ejected from the tip end portion 21 of the collection needle 1 together with the sample 20. After the solution 10 has once been ejected, the plunger 85 will be returned to the position prior to the ejection of the solution 10 for the purpose of preventing the solution 10 from flowing out of the tip end portion 21 of the collection needle 1. In this way, the solution 10 remaining in the needle inner flow path 22 and the third capillary tube 46 will be returned to the barrel 84. The amount of the solution 10 ejected is determined by the length of time during which the plunger 85 is being pushed downward. The syringe 83 (barrel 84 and plunger 85), the solenoid 87 and the reservoir 88 compose the liquid-inflow mechanism of the present invention.

In a case where the collection of the sample 20 is continuously conducted multiple times, the amount of the solution 10 ejected will increase, whereas the amount of the solution in the barrel 84 will decrease. For this reason, the reservoir 88 for reserving the solution 10 is provided on the outer side of the barrel 84 for the purpose of feeding the barrel 84 with the solution 10. A small hole 89 is made in the outer wall of the barrel 84, and the reservoir 88 and the through hole 89 are thus connected with each other in a way such that the solution 10 reserved in the reservoir 88 can be supplied to the barrel 84. As shown in FIG. 14, before discharging the sample 20 being held in the needle inner flow path 22, a gasket 90 of the plunger 85 is positioned above the feeding hole 89. In such state, the barrel 84 and the reservoir 88 are connected with each other through the feeding hole 89. The solenoid 87 will operate to push the plunger 85 downward from this position, and when the gasket 90 has reached the level at which the feeding hole 89 is blocked thereby or lower, the solution 10 inside the barrel 84 and the solution 10 inside the reservoir 88 will be separated from each other. As the plunger 85 is further pushed downward, the solution 10 inside the barrel 84 will flow in the third capillary tube 46 and the needle inner flow path 22 before being discharged into the reaction chamber 37 together with the sample 20 collected. Later, the plunger 85 will be lifted upward by the solenoid 87 so that solution 10 remaining in the needle inner flow path 22 and the third capillary tube 46 will be returned to the barrel 84. As the plunger 85 is further lifted upward, the gasket 90 will be positioned above the feeding hole 89. There, once the barrel 84 and the reservoir 88 have been connected with each other through the feeding hole 89, the solution 10 inside the reservoir 88 will flow into the barrel 84. When the plunger 85 has returned to and stopped at its initial position shown in FIG. 14, the solution 10 of an amount identical to that of the solution 10 ejected will be supplied from the reservoir 88 to the barrel 84. In this way, collection can be continuously performed for a significant number of times without disrupting each collection process so as to feed the barrel 84 with the solution 10. Further, the amount of the solution 10 ejected can be adjusted by changing the length of time during which the plunger 85 is being pushed downward. In addition, there may also be employed a valve mechanism (not shown) for controlling the flow of the solution.

In a case where, for example, collection is continuously performed only a few times, and the reservoir 88 is thus not used, there will be used a syringe 83 with no feeding hole 89 formed thereon. In such case, the extent or amount by which the plunger 85 is lifted after discharging the sample 20 is set to be equal to the amount of the solution 10 that will be returned to the barrel 84 after having remained in the collection needle 1 and the third capillary tube 46. That is, the plunger 85 stops when it has come down from its initial position by a distance equal to the amount of the solution 10 ejected.

Here, a sequence of steps from collecting the sample 20 to the recovery thereof in the present example is described. In the beginning, the holding sheet 7 is laid on the petri dish 71, followed by placing the biological specimen 3 on such holding sheet 7. Although the cover film 6 is not used in this example, the biological specimen 3 may also be covered by the cover film 6 at that time if necessary. Next, the petri dish 71 is to be mounted in the mounting groove 73 of the petri dish holder 72, followed by pushing the petri dish 71 with the fixation pin 74 so as to push it to one side in the mounting groove 73 and then fix it there so that it will not move. Here, the setting of the petri dish 71 is thus completed. Next, displayed on the monitor 14 is the image of the biological specimen 3 observed by the inverted microscope 13 from underneath the petri dish 71. A collection site is then determined while looking at such image; and once the collection process of the sample 20 has begun via the controller 27, the specimen holder actuation mechanism 80 will cause the petri dish holder 72 to move such that the collection site will be arranged at the collection position. Next, the collection needle 1 comes down to cut the biological specimen 3 and collect the sample 20. It will suffice if the collection needle 1 is capable of completely cutting the biological specimen 3 and collecting the sample 20. In this regard, the setting of the moving distance of the collection needle 1 can be such that the collection needle 1 stops at a position where a part of the upper side of the protection sheet 7 is cut, so that the tip end portion 21 of the collection needle 1 can be prevented from colliding with the petri dish 71. Particularly, in a case where the sample 20 to be collected resides inside the biological specimen 3 which is too thick to be penetrated, such target sample 20 can be collected by setting the moving distance of the collection needle 1 in a way such that the tip end portion 21 of the collection needle 1 will stop inside the biological specimen 3. At that time, although the surface layer portion of the biological specimen 3 is cut into the shape of the inner region of the tip end portion 21 of the collection needle 1 i.e. the shape of a thin cylinder, the lower end portion of such cylinder will not be cut because of the thickness of the specimen, which at times makes it impossible for the sample 20 to be collected inside the collection needle 1 when lifting the collection needle 1. In such case, the collection needle 1 may be vibrated or rotated as mentioned above, so that the lower end portion of the cylinder can be easily cut. After collecting the sample 20, the collection needle 1 will move to a position that is above a designated reaction chamber 37 of the titer plate 15 and stop there. Here, the solenoid 87 will operate to push the plunger 85 downward such that the solution 10 in the barrel 84 will flow into the needle inner flow path 22, and that the sample 20 will then be discharged into the reaction chamber 37 together with the solution 10. At that time, the inner region of the collection needle 1 can be washed as the solution 10 flows inside the needle inner flow path 22. In this way, there is no need to detach the collection needle 1 for cleaning up, and the collection needle 1 may thus be used repeatedly. The amount of the solution 10 flowing into the collection needle 1 is set to an amount capable of ejecting the sample 20 and washing the inner region of the collection needle 1 e.g. an amount of 2 to 3 μl. After discharging the sample 20, the collection needle 1 will return to the initial position and stop there.

In a case where multiple collection sites are determined, and multiple samples 20 are then collected in a successive manner, the collection needle 1 collects the samples 20, and the petri dish holder 72 moves in a way such that the next collection site will be arranged at the collection position, while the collection needle 1 is discharging the sample(s) 20 in the titer plate 15. The collection needle 1 will not return to the initial position after discharging the sample 20 into the titer plate 15, but will start collecting the sample 20 from the next collection site. After collecting the samples 20 from all the collection sites determined and then discharging them into the titer plate 15, the collection needle 1 will return to the initial position and stop there.

Next, with reference to FIG. 4 and FIG. 14, described is the electrical structure of the sequence of the steps from the collection of the sample 20 to the recovery thereof. After turning on the sample collection system by the controller 27, and then setting the biological specimen 3-placed petri dish 71 to the mounting groove 73 of the petri dish holder 72, a command from the control device 31 will cause the video camera 35 to capture an image observed by the inverted microscope 13, and such image to then be displayed on the monitor 14. Once a desired collection site has been input by the controller 27, the position information of the collection site will be calculated based on a distance from the Z axis as the reference to the collection site. A command signal from the control device 31 that is based on this position information will activate the specimen holder actuation mechanism 80 such that the collection site will be positioned on the Z axis (collection position). Although the Z axis serves as the reference in this example, a position other than the Z axis may also be set as the reference. By setting a reference in such manner, there is no need to provide the position coordinates of the holding sheet 7 and the petri dish 71. Once the specimen holder actuation mechanism 80 has stopped operating, a command signal from the control device 31 will activate the collection needle actuation mechanism 2 so that the collection needle 1 will come down. Here, a distance by which the collection needle 1 descends from the initial position is previously determined and stored in the memory device 30. After the collection needle 1 has collected the sample 20, the position information of the reaction chamber 37 that is previously determined and stored in the memory device 30 will be read out, and a command signal from the control device 31 will then activate the collection needle actuation mechanism 2 such that the collection needle 1 can be moved to a position above the reaction chamber 37 read out and stopped there. Later, a command signal from the control device 31 will activate the solenoid 87 to allow the solution 10 to flow out of the syringe 83, and the sample 20 to then be ejected from inside the needle inner flow path 22 into the reaction chamber 37. In a case where the sample(s) 20 is collected in a successive manner, a command signal from the control device 31 will activate the specimen holder actuation mechanism 80 such that the next collection site will be positioned on the Z axis (collection position), while the collection needle 1 is storing the collected sample(s) 20 into the reaction chamber 37. After the sample(s) 20 have been collected from all the collection sites determined and then discharged into the titer plate 15, a command signal from the control device 31 will activate the collection needle actuation mechanism 2 to allow the collection needle 1 to return to the initial position.

The designation of a collection site(s) can, for example, be conducted by determining a first collection site, and then performing collection for a given number of times at a given interval along the X axis direction and the Y axis direction. The intervals between neighboring collection sites may be either equal or unequal. By employing such setting, multiple samples 20 can be collected from within a specific range of the biological specimen 3. Further, in a case where the biological specimen 3 is, for example, frozen, and it is difficult to individually determine a collection site since the biological specimen 3 cannot be clearly observed, the sample 20 can still be conveniently collected from within a given range.

As described above, the sample collection system of the present example includes the petri dish 71 for placing the biological specimen 3; the petri dish holder 72 for placing the petri dish 71; and the titer plate 15 for storing the sample(s) 20 collected. In this way, the sample(s) 20 can be collected from the biological specimen 3 placed on the petri dish 71, and then stored in the reaction chamber(s) 37 of the titer plate 15. Further, as a container for placing the biological specimen 3, a commercially available petri dish 71 may be used; and as a storage portion for storing the sample 20 collected, a commercially available titer plate 15 may be used.

Further, the sample collection system of the present example includes the collection needle actuation mechanism 2 for moving the collection needle 1; and the specimen holder actuation mechanism 80 for moving the petri dish holder 72. In this way, the collection needle 1 which requires large movements and the petri dish holder 72 which requires fine movements can be moved through different actuation systems, thus shortening the time from the collection of the sample 20 to the recovery thereof. In this example, although the sample 20 is to be collected by cutting the biological specimen 3, the sample 20 may in fact be sucked and collected by the collection needle 1 depending on a target.

With reference to the following Table 1, described are the superiorities of the sample collection system of the invention of the present application as compared to some of the conventional sample collection devices marketed by companies A, B and C. The product by company A is a so-called laser microdissection device. The product by company B is a device for sucking and recovering target cells, where cells are to be seeded on a microplate having many microchambers, and then detected with fluorescent labels via antigen-antibody reaction. The product by company C is a device for picking one cell/tissue by a vacuum method. After this product has collected a sample, it is required that its collection needle be removed, and a new collection needle be then installed after recovering the sample.

As shown in Table 1, since the product by company A does not use a needle, there is no need to replace a needle. However, since a recovery container has to be replaced per one cycle of a collection process, the operation is cumbersome, and a collection time has been extremely lengthy. The product by company B is only usable for blood cells, and can thus not be used to collect a sample from a biological specimen. As for the product by company C, a needle and a recovery container have to be replaced per one cycle of a collection process, which makes the collection operation extremely cumbersome and results in a lengthy collection time of a sample. As a result of comparing these products with the sample collection system of the invention of the present application, the sample collection system of the invention of the present application allows living cells and tissue fragments to be collected, and exhibits a collection time significantly shorter than those of the products by companies A to C. Further, since the solution 10 washes the needle inner flow path 22 as the inner region of the collection needle 1, there is no need to replace the needle (collection needle 1). In addition, until the reaction chambers 37 have all been occupied, there is no need to replace the recovery container (titer plate 15). In this way, as compared to the conventional products by companies A to C, the invention of the present application is capable of shortening the time required to collect a sample(s), and making the operation dramatically simpler.

TABLE 1

| | | Present | Product by | Product by | Product by |
|---|---|---|---|---|---|
| | | invention | company A | company B | company C |
| Collection | | Punching · | Laser | Suction · | Suction · |
| method | | Ejection | cutout | Ejection | Ejection |
| Collection | Living | ◯ | ◯ | Δ (Only | ◯ |
| target | cell | | | blood cell) | |
| | Tissue | ◯ | ◯ | X | ◯ |
| | fragment | | | | |

| | | | | |
|---|---|---|---|---|
| Collection | 8 min | 10 hours | 50 to | 10 hours |
| time | | or longer | 100 min | or longer |
| (100 sites) | | | or longer | |
| Needle | Not | — | Not | Required |
| replacement | required | | required | (per 1 cycle |
| | | | | of |
| | | | | collection |
| | | | | process) |
| Recovery | Not | Required | Not | Required |
| container | required | (per 1 cycle | required | (per 1 cycle |
| replacement | | of | | of |
| | | collection | | collection |
| | | process) | | process) |

As described above, the sample collection system of the present example(s) includes the petri dish 71 for placing the biological specimen 3; the petri dish holder 72 for mounting the petri dish 71; and the titer plate 15 for storing the sample 20 collected. In this way, the sample 20 collected from the biological sample 3 placed on the petri dish 71 can be stored in the titer plate 15.

Further, the sample collection system of the present example(s) includes the collection needle actuation mechanism 2 for moving the collection needle 1; and the specimen holder actuation mechanism 4 for moving the petri dish holder 72. In this way, the collection needle 1 and the petri dish holder 72 can be activated independently from each other.

Furthermore, the sample collection system of the present example(s) includes the vibration mechanism for vibrating the collection needle 1; and the rotation mechanism for rotating the collection needle 1, which allows the collection needle 1 to thus be provided in a vibratable and rotatable manner. In this way, it is easier for the collection needle 1 to cut the biological specimen 3 and then collect the sample 20.

However, the present invention is not limited to the above examples, but may be variously modified within the scope of the gist of the present invention. For example, in the above examples, when discharging the sample collected into the collection needle from the tip end of the collection needle, there may be employed a configuration where after a given amount of the solution has flowed into the collection needle, air may be supplied thereinto so as to push out the sample by air pressure.

What is claimed:

1. A sample collection system comprising:
one or multiple hollow collection needles each having a knife edge for collecting samples from a biological specimen; and
a liquid-inflow mechanism to flow liquid through the inner region of each hollow collection needle,
wherein the samples are recovered by ejecting the samples from the collection needles together with the liquid.

2. The sample collection system set forth in claim 1, further comprising:
a collection needle actuation mechanism to move the collection needle;
a specimen placement container to place the biological specimen therein;
a specimen holder to hold the specimen placement container; and
a specimen holder actuation mechanism to move the specimen holder.

3. The sample collection system set forth in claim 1, further comprising:
a specimen placement container to place the biological specimen therein;
a specimen holder to hold the specimen placement container;
a storage portion to store the samples;
a collection needle actuation mechanism to move the collection needle along a first axial direction when collecting the samples; and
a storage portion actuation mechanism to move the storage portion along at least a second axial direction orthogonal to the first axial direction,
wherein the storage portion includes multiple reaction chambers to store the samples.

4. The sample collection system set forth in claim 1, further comprising one or multiple fluidic channels along which the samples flow together with liquid, wherein the samples are allowed to flow by the flow of the liquid in the fluidic channels.

5. The sample collection system set forth in claim 4, further comprising a holding body to hold the biological specimen in a manner capable of being cut and penetrated by the collection needle, wherein the fluidic channels are provided below the holding body, and the tip end portion of the collection needle is arranged above the fluidic channel in the transverse direction thereof.

6. The sample collection system set forth in claim 4, further comprising:
a holding body to hold the biological specimen in a manner capable of being cut and penetrated by the collection needle;
a specimen holder to mount the holding body thereon; and
a mounting board to mount the specimen holder thereon,
wherein the fluidic channel is provided on the specimen holder or the mounting board, and wherein the system further comprises one or multiple sample collection gates that are communicated with the fluidic channel and are arranged below the holding body.

7. The sample collection system set forth in claim 4, wherein the tip end portion of the collection needle is insertable into the fluidic channel or the sample collection gates communicated with the fluidic channel.

8. The sample collection system set forth in claim 4, further comprising a sample preparation system for analyzing or examining the samples, wherein the fluidic channel or the collection needle is communicated with the sample preparation system.

9. The sample collection system set forth in claim 1, further comprising an observation device to determine at which site in a biological specimen the sample is to be collected according to image information on the specimen obtained by the observation device.

10. The sample collection system set forth in claim 3, wherein the storage portion moves independently from the relative movement of the specimen holder and the collection needle, and is capable of moving faster than the relative motion of the specimen holder and the collection needle.

11. The sample collection system set forth in claim 1, further comprising a holding body to hold the biological specimen in a manner capable of being cut and penetrated by the collection needle, wherein reference point(s) or reference line(s) are provided on the holding body in order to determine a position on the two-dimensional coordinates, and the coordinates of the collection sites can thus be determined based on the reference point(s) or reference line(s).

12. The sample collection system set forth in any one of claim 1, further comprising:
a holding body to hold the biological specimen in a manner capable of being cut and penetrated by the collection needle;
a specimen holder to hold the holding body holding the biological specimen; and
a specimen holder actuation mechanism to move the specimen holder,
wherein the two-dimensional coordinates of the holding body can be transformed into the two-dimensional coordinates of the specimen holder or the two-dimensional coordinates of the specimen holder actuation mechanism.

13. The sample collection system set forth in claim 1, further comprising a collection needle actuation mechanism to move the collection needle along a first axial direction when collecting the samples, wherein the collection needle is movable on a plane orthogonal to the first axial direction along which the collection needle goes down to cut or penetrate the specimen.

14. The sample collection system set forth in claim 3, further comprising one or multiple fluidic channels along which the samples flow together with liquid, wherein the samples are allowed to flow by the flow of the liquid in the fluidic channels.

15. The sample collection system set forth in claim 7, further comprising a sample preparation system for analyzing or examining the samples, wherein the fluidic channel or the collection needle is communicated with the sample preparation system.

16. The sample collection system set forth in claim 2, further comprising an observation device to determine at which site in a biological specimen the sample is to be collected according to image information on the specimen obtained by the observation device.

17. The sample collection system set forth in claim 3, further comprising an observation device to determine at which site in a biological specimen the sample is to be collected according to image information on the specimen obtained by the observation device.

18. The sample collection system set forth in claim 4, further comprising an observation device to determine at which site in a biological specimen the sample is to be collected according to image information on the specimen obtained by the observation device.

19. The sample collection system set forth in claim 7, further comprising an observation device to determine at which site in a biological specimen the sample is to be collected according to image information on the specimen obtained by the observation device.

20. The sample collection system set forth in claim 8, further comprising an observation device to determine at which site in a biological specimen the sample is to be collected according to image information on the specimen obtained by the observation device.
